(19) United States
(12) Patent Application Publication
(10) Pub. No.: US 2024/0369096 A1
(43) Pub. Date: Nov. 7, 2024

(54) INTEGRATED COMPOSITE DRIVE SHAFTS

(71) Applicant: Goodrich Corporation, Charlotte, NC (US)

(72) Inventors: Mark R. Gurvich, Middletown, CT (US); Brayton Reed, New York Mills, NY (US); Michael J. King, Sauquoit, NY (US); Michael Streeter, Mohawk, NY (US); Joyel Schaefer, Earlville, NY (US)

(21) Appl. No.: 18/776,744

(22) Filed: Jul. 18, 2024

Related U.S. Application Data
(63) Continuation-in-part of application No. 18/127,584, filed on Mar. 28, 2023.

(51) Int. Cl. F16C 3/02

(52) U.S. Cl. CPC F16C 3/026

(57) ABSTRACT

Composite shafts and methods of making the same are described. The composite shafts include a plurality of composite elements arranged about an axis. The composite elements include first and second groups arranged at offset angles ±α. The groups of composite elements are configured to cooperate to allow the shaft to be flexible under bending and/or axial load and stiff under rotational load. The hollow shaft includes one or more axisymmetric radially-outward undulating portions and one or more axisymmetric narrow portions. The composite elements of groups are connected together in the radial direction along the narrow portions and the composite elements of the groups are not connected together in the radial direction along the undulating portions.

### CROSS-REFERENCE TO RELATED APPLICATIONS

This application is a Continuation-in-Part of the legally related U.S. application Ser. No. 18/127,584 filed Mar. 28, 2023, the contents of which are incorporated by reference herein in their entirety.

### BACKGROUND

The present disclosure relates to drive shafts, and more particularly to integrated, composite drive shafts.

Among other structural requirements, drive shafts have to provide two seemingly conflicting structural responses, namely, to be stiff and strong under torque, but also to be flexible under axial and bending deformations. Such flexibility is needed to compensate for inevitable lateral and axial movements of shafts during service and/or to take into account potential imperfections of shaft installations. Current methods to resolve this dilemma are usually resolved by using metallic flexible couplings and/or diaphragms connected to opposite ends of a hollow cylindrical shaft with constant cross-section along its longitudinal axis. Thus, the metallic couplings provide the flexibility, and the cylindrical shaft provides the torsional load transfer. While cylindrical shaft bodies can be either metallic or composite, the couplings are predominantly metallic. Therefore, such conventional drive shafts can be relatively expensive due to requirements of high-precision fabrication and high-quality control requirements of metallic couplings. In addition to cost and labor, the metallic coupling can significantly contribute to overall weight of integrated coupling and shaft body systems.

Conventional techniques have been considered satisfactory for their intended purposes. However, there is an ever present need for improved systems and methods for flexible composite drive shafts and making the same. This disclosure provides a solution of integrated design of flexible composite drive shafts and method of making such flexible composite drive shafts.

### SUMMARY

According to some embodiments, composite shafts are provided. The composite shafts include a plurality of composite elements arranged about an axis to form a hollow axisymmetric shaft. The plurality of composite elements includes a first group of the composite elements arranged about the axis offset by an angle +α and a second group of the composite elements arranged about the axis offset by an angle −α to form a web with the first group of the composite elements. The first and second groups of the plurality of composite elements are configured to cooperate to allow the hollow shaft to be flexible under bending and/or axial load and stiff under rotational load. The hollow shaft includes one or more axisymmetric radially-outward undulating portions and one or more axisymmetric narrow portions. The narrow portions define a minimum inner diameter of the hollow shaft and the undulating portions define bulges having a larger inner diameter than the minimum inner diameter. The composite elements of the first group are connected to the composite elements of the second group in the radial direction along the narrow portions and the composite elements of the first group are not connected to the composite elements of the second group in the radial direction along the undulating portions.

In addition to one or more of the features described herein, or as an alternative, further embodiments of the composite shafts may include that the second group is applied radially outward from the first group.

In addition to one or more of the features described herein, or as an alternative, further embodiments of the composite shafts may include a third group of the composite elements arranged about the axis offset by the angle +α to form a web with the first and second groups of the composite elements.

In addition to one or more of the features described herein, or as an alternative, further embodiments of the composite shafts may include that the second group of composite elements has a material thickness in the radial direction that is approximately equal to a material thickness of the first group plus the third group in the radial direction.

In addition to one or more of the features described herein, or as an alternative, further embodiments of the composite shafts may include that a radial gap is defined between the composite elements of the first group and the composite elements of the second group along an axial length of the undulating portion.

In addition to one or more of the features described herein, or as an alternative, further embodiments of the composite shafts may include that the hollow shaft comprises a plurality of axisymmetric radially-outward undulating portions and a plurality of narrow portions that are arranged in an alternating pattern with each undulating portion arranged between two narrow portions on either side of the undulating portion in an axial direction.

In addition to one or more of the features described herein, or as an alternative, further embodiments of the composite shafts may include one or more reinforcement elements arranged at the narrow portions.

In addition to one or more of the features described herein, or as an alternative, further embodiments of the composite shafts may include that the one or more reinforcement elements comprise composite elements arranged at least one of axially, circumferentially, or at a non-zero angle about the hollow shaft.

In addition to one or more of the features described herein, or as an alternative, further embodiments of the composite shafts may include that each of the angle +α and the angle −α is between 30 and 60 degrees.

According to some embodiments, methods of making composite shafts are provided. The methods include providing a mandrel having a substantially cylindrical shape and defining an axis, installing one or more first inserts along an axial length of the mandrel, arranging a first group of axisymmetric composite elements about the axis offset by an angle +α, wherein the first group of composite elements is applied to the mandrel along axial lengths defining narrow portions of a formed composite shaft and the first group of composite elements is applied to the one or more first inserts along axial lengths defining one or more undulating portions of the formed composite shaft, installing one or more second inserts along the axial length of mandrel, wherein at least one of the one or more first inserts has a respective second insert installed radially outward therefrom and axially aligned therewith, and arranging a second group of composite elements arranged about the axis offset by an angle −α to form a web with the first group of composite elements, wherein the second group of composite elements is applied to the first group of composite elements along the axial lengths defining the narrow portions of the formed composite shaft and the second group of composite elements is applied to the one or more second inserts along the axial lengths defining the one or more undulating portions of the formed composite shaft.

In addition to one or more of the features described herein, or as an alternative, further embodiments of the methods may include that the composite elements are made of thermoset materials, the method further comprising performing a curing operation to harden the thermoset material.

In addition to one or more of the features described herein, or as an alternative, further embodiments of the methods may include installing one or more third inserts along the axial length of mandrel, wherein the one or more first insert having a respective second insert has a respective third insert installed radially outward from the second insert and axially aligned therewith and arranging a third group of composite elements arranged about the axis to form a web with the first and second groups of composite elements, wherein the third group of composite elements is applied to the second group of composite elements along the axial lengths defining the narrow portions of the formed composite shaft and the third group of composite elements is applied to the one or more third inserts along the axial lengths defining the one or more undulating portions of the formed composite shaft.

In addition to one or more of the features described herein, or as an alternative, further embodiments of the methods may include that the second group of composite elements has a material thickness in the radial direction that is about equal to a material thickness in the radial direction of the first group plus a similar thickness of the third group in the radial direction.

In addition to one or more of the features described herein, or as an alternative, further embodiments of the methods may include that the composite elements are made of thermoset materials, the method further comprising performing a curing operation to harden the thermoset material.

In addition to one or more of the features described herein, or as an alternative, further embodiments of the methods may include removing the mandrel, the one or more first inserts, the one or more second inserts, and the one or more third inserts, to leave gaps between the first group of composite elements and the second group of composite elements along the axial length of the undulating portions and to leave gaps between the second group of composite elements and the third group of composite elements along the axial length of the undulating portions.

In addition to one or more of the features described herein, or as an alternative, further embodiments of the methods may include removing the mandrel, the one or more first inserts, and the one or more second inserts to leave gaps between the first group of composite elements and the second group of composite elements along the axial length of the one or more undulating portions.

In addition to one or more of the features described herein, or as an alternative, further embodiments of the methods may include that each of the one or more first inserts each comprises a segmented ring.

In addition to one or more of the features described herein, or as an alternative, further embodiments of the methods may include that each of the one or more second inserts each comprises a segmented ring.

In addition to one or more of the features described herein, or as an alternative, further embodiments of the methods may include installing reinforcement elements at the narrow portions.

In addition to one or more of the features described herein, or as an alternative, further embodiments of the methods may include that the reinforcement elements comprise composite elements arranged at least one of axially, circumferentially, or at a non-zero angle about the hollow shaft.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a side elevation view of a composite shaft in accordance with an embodiment of the present disclosure, showing a side profile of the shaft;

FIG. 2 is an enlarged partial side view of an embodiment of a composite shaft in accordance with an embodiment of the present disclosure, showing a composite web structure thereof;

FIG. 3 is an enlarged partial side view of an embodiment of a composite shaft in accordance with the present disclosure, showing a portion of a composite web structure;

FIG. 4A is a deformation diagram schematically illustrating an axial cross-section of a composite shaft in accordance with an embodiment of the present disclosure, when under tension;

FIG. 4B is a deformation diagram schematically illustrating an axial cross-section of a composite shaft in accordance with an embodiment of the present disclosure, when under compression;

FIG. 5 is an enlarged partial side view of a composite shaft in accordance with an embodiment of the present disclosure, showing another composite web structure;

FIG. 6 is an enlarged partial side view of an embodiment of a composite shaft in accordance with the present disclosure, showing another composite web structure;

FIG. 7 is an enlarged partial side view of an embodiment of a composite shaft in accordance with the present disclosure, showing another composite web structure;

FIG. 8 is an enlarged partial view of the composite web structure of FIG. 7 at an intersection of composite elements;

FIG. 9A is an enlarged cross-sectional view of an intersection of elements in accordance with an embodiment of the present disclosure, showing a relative placement of plies of the composite elements in a stacked configuration;

FIG. 9B is an enlarged cross-sectional view of an intersection of elements in accordance with an embodiment of the present disclosure, showing a relative placement of plies of the composite elements in an interleaved configuration;

FIG. 9C is an enlarged cross-sectional view of the intersection of elements in accordance with an embodiment of the present disclosure, showing another relative placement of plies of composite elements in an interleaved configuration with, at least, one reinforcing pad;

FIG. 10 is an enlarged partial side view of an embodiment of a composite shaft in accordance with an embodiment of the present disclosure, showing another composite web structure having additional axial strands;

FIG. 11 is an enlarged partial view of a composite web structure of the configuration of FIG. 10 at an intersection of composite elements;

FIG. 12 is an enlarged partial side view of an embodiment of a composite shaft in accordance with an embodiment of the present disclosure, showing another composite web structure having additional circumferential hoops;

FIG. 13 is an enlarged partial view of the composite web structure of FIG. 12 at an intersection of composite elements;

FIG. 14 is an enlarged partial side view of an embodiment of a composite shaft in accordance with an embodiment of the present disclosure, showing another composite web structure having additional axial strands and circumferential hoops;

FIG. 15 is an enlarged partial view of the composite web structure of FIG. 14 at an intersection of composite elements;

FIG. 16A is a side perspective view of a composite shaft in accordance with an embodiment of the present disclosure, having an arrangement of circumferential hoops arranged along the shaft;

FIG. 16B is a side perspective view of a composite shaft having another arrangement of circumferential hoops arranged along the shaft;

FIG. 16C is a side perspective view of a composite shaft having another arrangement of circumferential hoops arranged along the shaft;

FIG. 16D is a side perspective view of a composite shaft having another arrangement of circumferential hoops arranged along the shaft;

FIG. 16E is a side perspective view of a composite shaft having another arrangement of circumferential hoops arranged along the shaft;

FIG. 17 is an axial cross-sectional view of a composite shaft having a constant diameter profile with added undulations in accordance with an embodiment of the present disclosure;

FIG. 18 is an axial cross-sectional view of a composite shaft having a convex profile with added undulations in accordance with an embodiment of the present disclosure;

FIG. 19 is an axial cross-sectional view of a composite shaft having concave profile with added undulations in accordance with an embodiment of the present disclosure;

FIG. 20 is an axial cross-sectional elevational view of an embodiment of a method of making a composite shaft in accordance with an embodiment of the present disclosure;

FIG. 21 is an axial cross-sectional side elevational view of another embodiment of a method of making a composite shaft in accordance with an embodiment of the present disclosure;

FIG. 22 is an axial cross-sectional side elevational view of another embodiment of a method of making a composite shaft in accordance with an embodiment of the present disclosure;

FIG. 23 is a perspective view of an undulation area of the method of making a composite shaft of FIG. 22;

FIG. 24 is an axial cross-sectional side elevational view of another embodiment of a method of making a composite shaft in accordance with an embodiment of the present disclosure;

FIG. 25 is a perspective view of an undulation area of the method of making a composite shaft of FIG. 24;

FIG. 26 is a schematic axial cross-sectional view of a portion of a composite shaft in accordance with another embodiment of the present disclosure formed from two groups of composite elements;

FIG. 27 is a schematic axial cross-sectional view of a portion of a composite shaft in accordance with another embodiment of the present disclosure formed from three groups of composite elements;

FIG. 28 is a schematic axial cross-sectional view of a portion of a composite shaft in accordance with another embodiment of the present disclosure formed from three groups of composite elements and having reinforcement elements;

FIG. 29A is a schematic axial cross-sectional view of a first step of a manufacturing process for forming a composite shaft in accordance with an embodiment of the present disclosure, illustrating an assembly of the manufacturing process;

FIG. 29B is a schematic axial cross-sectional view of a second step of the manufacturing process applying an insert to the mandrel of the assembly;

FIG. 29C is a schematic axial cross-sectional view of a third step of the manufacturing process applying a first composite layer to the assembly;

FIG. 29D is a schematic axial cross-sectional view of a fourth step of the manufacturing process applying a second insert to the assembly;

FIG. 29E is a schematic axial cross-sectional view of a fifth step of the manufacturing process applying a second composite layer to the assembly;

FIG. 29F is a schematic axial cross-sectional view of a sixth step of the manufacturing process applying a third insert to the assembly;

FIG. 29G is a schematic axial cross-sectional view of a seventh step of the manufacturing process applying a third composite layer to the assembly;

FIG. 29H is a schematic axial cross-sectional view of an eighth step of the manufacturing process with a mandrel removed from the assembly;

FIG. 29I is a schematic axial cross-sectional view of a ninth step of the manufacturing process with the inserts removed from the assembly, leaving a formed composite shaft;

FIG. 30A is a schematic cross-sectional view of a first set of inserts in accordance with an example embodiment of the present disclosure;

FIG. 30B is a schematic cross-sectional view of a second set of inserts in accordance with an example embodiment of the present disclosure; and

FIG. 31 is a flow process for manufacturing a composite shaft in accordance with an embodiment of the present disclosure.

### DETAILED DESCRIPTION

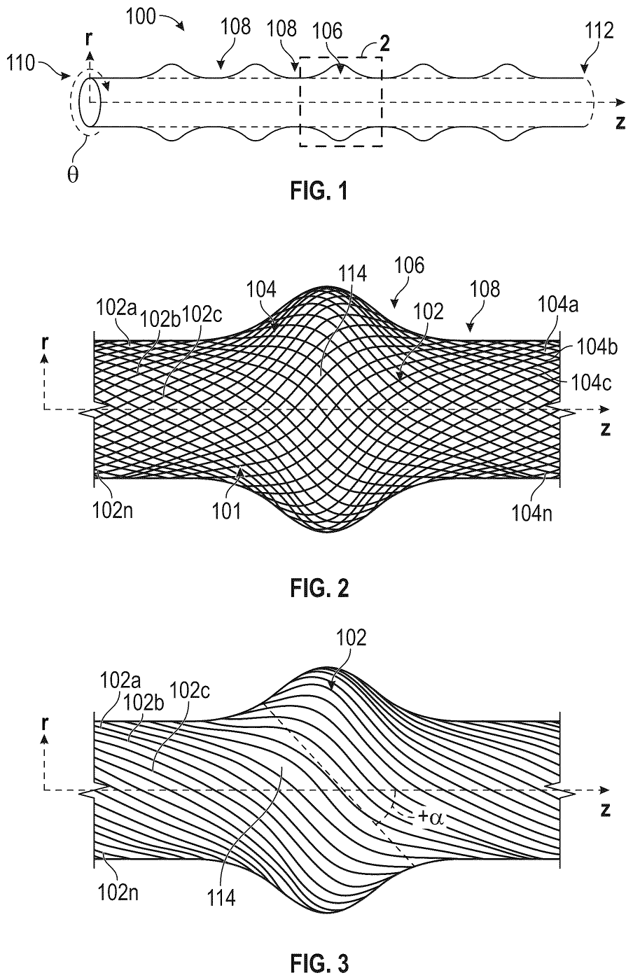

Reference will now be made to the drawings wherein like reference numerals identify similar structural features or aspects of the subject disclosure. For purposes of explanation and illustration, and not limitation, an illustrative view of an embodiment of a composite shaft in accordance with the disclosure is shown in FIG. 1 and is designated generally by reference character 100. Other embodiments and/or aspects of this disclosure are shown and described herein.

Referring to FIGS. 1-4B, in accordance with at least one aspect of this disclosure, a composite shaft 100 can include a plurality of composite elements 101 arranged about an axis Z to form a hollow shaft (e.g., shaft 100). In certain embodiments, as shown, the shaft 100 can include one or more undulating portions 106 (e.g., a plurality shown in FIG. 1) and one or more of narrow portions 108 (e.g., a plurality shown in FIG. 1) between the undulating portions 106. The one or more undulating portions 106 can extend radially outward from the shaft and can be axisymmetric. Axial cross-sectional profiles of the undulated portions can be either symmetric or non-symmetric.

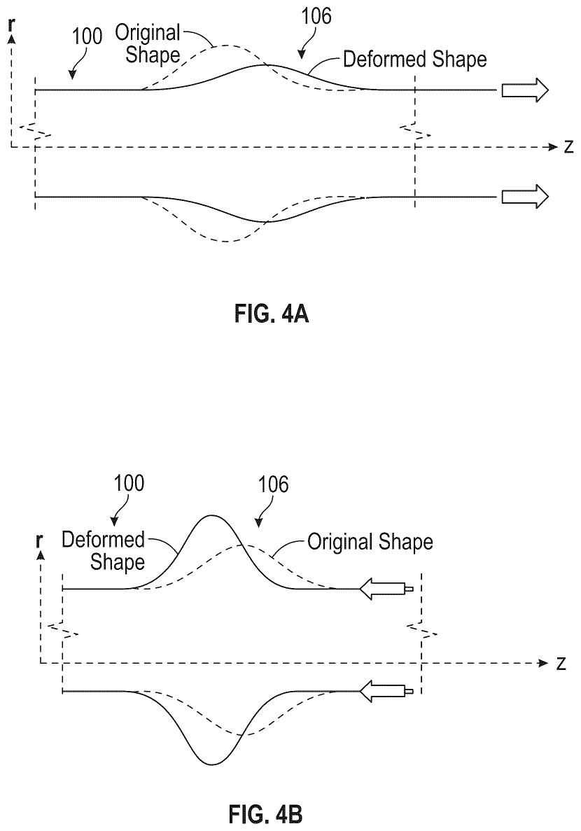

The plurality of composite elements 101 can include a first group 102 of the composite elements 101 arranged about the axis Z offset by an angle +α and a second group 104 of the composite elements 101 arranged about the axis offset by an angle −α to form a web with the first group 102 of composite elements 101. The angle a is measured relative to the axis Z and tangent to the surface of the shaft 100, e.g., as shown in FIG. 3, wherein only the first group 102 of composite elements 101 are shown. The first and second groups 102, 104 of the plurality of composite elements 101 can be configured to cooperate with one another to allow the hollow shaft 100 to be flexible under bending and/or axial load and stiff under rotational load, for example as shown in FIGS. 4A-4B, with FIG. 4A illustrating axial tension (e.g., a radial shrinking of the undulating portions 106), and FIG. 4B illustrating axial compression (e.g., a radial expansion of the undulation segments 106). The flexibility of a shaft under bending and/or axial load is considered as the ability to deform without generating significant risks of damage. The shaft 100 is stiffer around the axis Z in torsion than along the axis Z in bending and/or axial load. In other words, the shaft 100 can be configured to flex more along the axis Z than around the axis Z in torsion during rotation of the shaft 100.

In certain embodiments, the angle α can be between about 30° and about 60°. In certain embodiments, the angle α can be between about 35° and about 55°. In some embodiments, the angle α may be set at 45°. The angle +α can be constant or variable along or with respect to the axis Z, and the angle −α can be the same magnitude or a different magnitude than the angle +α, and can be constant or variable along or with respect to the axis Z within the second group 104 of composite elements or variable with respect to the angle +α. As shown herein, the angles +α and −α can be constant along the axial length of the shaft 100 and can be the same magnitude with respect to one another.

As shown in FIG. 2, and in accordance with some embodiments, the first group 102 of composite elements 101 can include a first plurality of individual composite elements 102a,b,c . . . n arranged in a spiral along the axis Z of the shaft 100 and oriented in a first spiral direction (e.g., clockwise as viewed from one axial end 110). The second group 104 of composite elements 101 can include a second plurality of individual composite elements 104a,b,c, . . . n arranged in a spiral along the axis Z of the shaft 100 and oriented in a second spiral direction opposite from of the first spiral direction (e.g., counterclockwise as viewed from the same axial end 110). The first and second spiral directions can be symmetric relative to the axis Z.

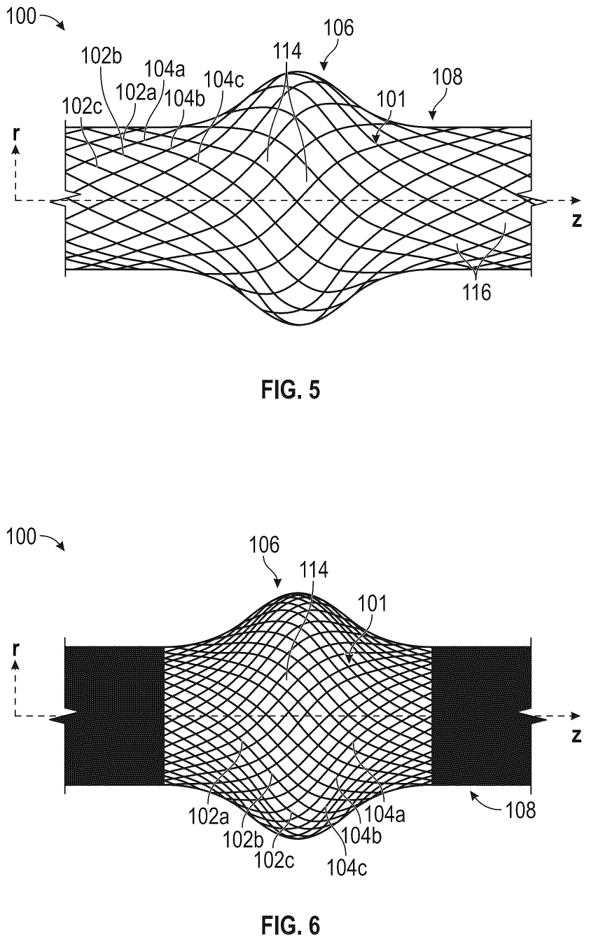

With reference now to FIGS. 5-6, in some embodiments, the first plurality of individual composite elements 102a,b,c . . . n can be circumferentially spaced from one another about the axis Z and the second plurality of individual composite elements 104a,b,c . . . n can be circumferentially spaced from one another about the axis Z such that a gap 114 is formed between each of individual composite elements 102a,b,c . . . n and a gap 114 is formed between each of individual composite element 104a,b,c . . . n. In certain such embodiments, a density of the plurality of composite elements 101 can be constant along the axis Z, where a density of the composite elements 101 refers to a relative area of the gap 114 between each individual composite element 101 of the plurality of composite elements 102, 104. In some embodiments, the composite elements 101 can have a constant density along the shaft 100 in an axial direction such that respective gap 114 formed between each of the individual composite elements 101 can have a constant size along the axial length of the shaft 100.

In certain embodiments, the plurality of composite elements 101 can have a variable density along the shaft 100 in an axial direction such that a respective gap 114 formed between each of the individual composite elements 101 has a different area. In some such embodiments, an element count (e.g., the number of individual composite elements 101 placed about the axis in the circumferential direction) may remain the same along the axial length of the shaft 100, while some portions of the shaft 100 may exhibit a tighter spiral density than others. For example, as shown in FIG. 6, where the gap 114 in all locations is smaller than the gap 114 shown in FIG. 5, showing that the shaft of FIG. 6 has more individual composite elements 101 than the shaft of FIG. 5. Also shown in FIG. 6, the gap 114 between composite elements 101 varies along the shaft 100 in the axial direction, where the undulating portions 106 have a wider gap 114 than the narrow portions 108 between the undulating portions 106. Thus, for the shaft 100 of FIG. 6, the undulating portions 106 have a lower density than the narrow portions 108, even though the number of composite elements 101 does not change between the two portions 106, 108 on the same shaft 100. In some embodiments, such as shown in FIG. 6, the density can be so high that virtually no gap 114 is formed between the component elements 101 and the individual composite elements 101 form a continuous shell or substantially solid portion, as shown on narrow portions 108 in FIG. 6.

In some embodiments, a density of the composite elements 101 can refer to an element count of composite elements 101 on the shaft 100 in the circumferential direction, where the element count remains constant along the shaft, regardless of whether the size of the gap 114 remains the same or varies. In some embodiments, the shaft 100 can have a low-density web with a relatively low number of composite elements 101, resulting in a large but constant gap 114 therebetween (e.g., FIG. 5). In other embodiments, the shaft 100 can have a high-density web with a high number of composite elements 101, resulting in a small but constant gap therebetween (e.g., FIG. 6). That is, as shown, the configuration of FIG. 5 has a relatively low-density web with large constant gaps 114, and the configuration of FIG. 6 has a relatively high-density web (e.g., higher than that of FIG. 5), as well as a variable density with respect to the gaps 114. Here, the shaft 100 of FIG. 5 has fewer composite elements 101 (e.g., fewer individual composite elements 101) than the shaft 100 shown in FIG. 6.

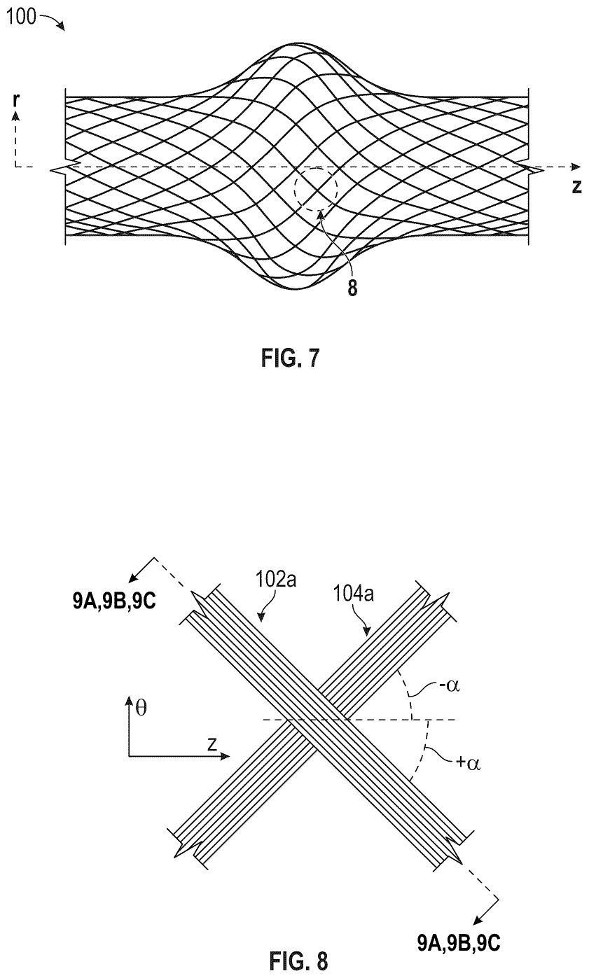

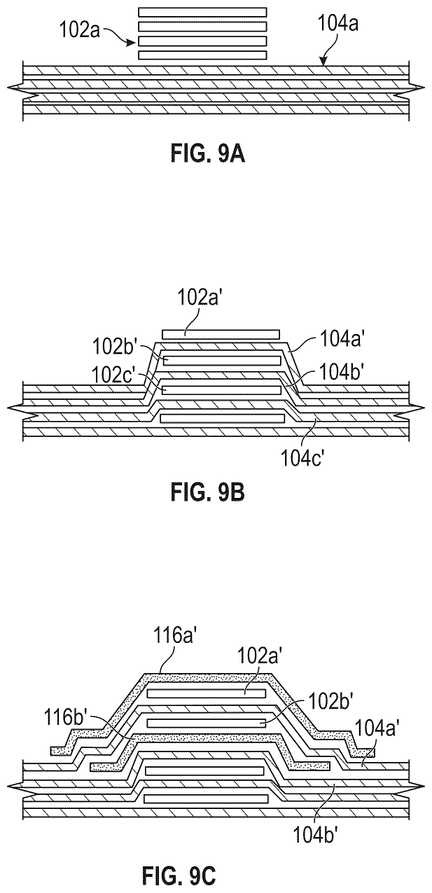

With reference now to FIGS. 7-9C, in some embodiments, each composite element (e.g., 102a, 104a) of the first and second plurality of individual composite elements 102, 104 can be formed of a plurality of plies, tapes, layers, strips, or the like (e.g., 102a′, 102b′, 102c′, 104a′, 104b′, 104c′). The plies can be overlaid on top of each other, as shown in FIG. 9A, with the plies of the first group 102 arranged as a stack or single group of plies on top of the plies of the second group 104, which are also arranged as a stack or single group of plies. As shown in FIGS. 9B-9C, alternative arrangements of the plies may be employed. For example, the plies of the first group 102 can be interleaved with the plies of the second group 104 (e.g., alternating between the first group of plies 102 and the second group of plies 104, layer by layer). In some embodiments, and as shown in FIG. 9C, the plies of the first group 102 of can be interleaved with the plies of the second group 104 and a reinforcing pad 116 (e.g., which may be formed of a plurality of plies 116a, 116b) having a length less than an axial length of the shaft 100, can be interleaved between the plies of the first group 102 and the plies of the second group 104. In certain such embodiments, the plies of the reinforcing pad 116 can be interleaved between each layer of the first and second groups 102, 104, or can be interleaved at varying intervals, for example, alternating every two or three layers, e.g., as shown in FIG. 9C.

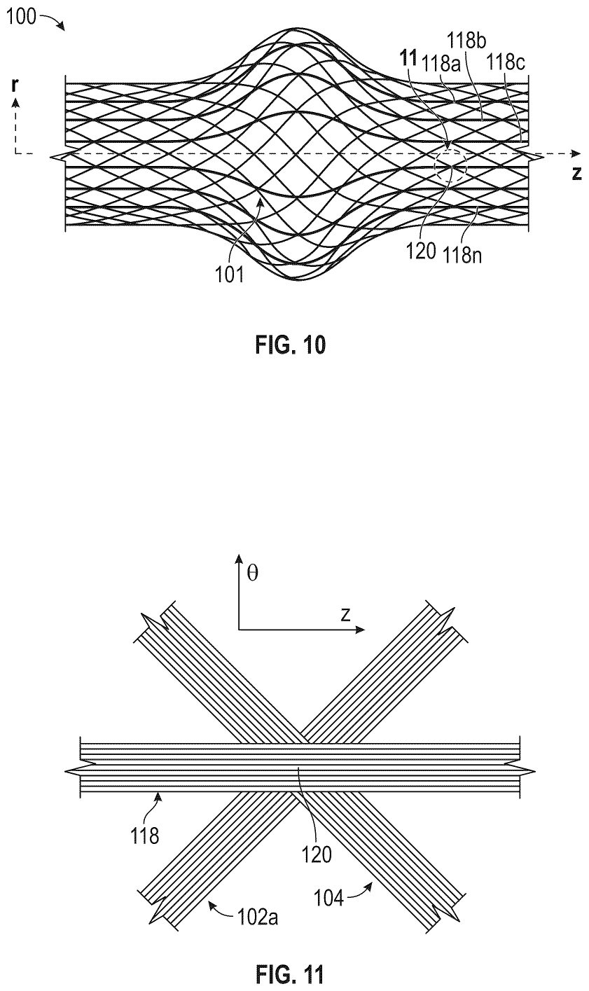

Referring now to FIGS. 10-11, in some embodiments, the plurality of composite elements 101 can include a third group 118 of composite elements arranged axially along the axis Z and circumferentially spaced apart from one another about the axis Z. The third group 118 of composite elements 101 can include a third plurality of individual composite elements 118a,b,c, . . . n laid along the axis Z as axial strands. Each composite element of the third group 118 can be formed as individual plies or as stacks or sets of plies. The third group 118 of composite elements can be arranged such that the elements intersect the first and second groups 102, 104 at respective intersections 120. The axial strands 118 can be placed circumferentially about the axis Z at regular, constant intervals or varying intervals.

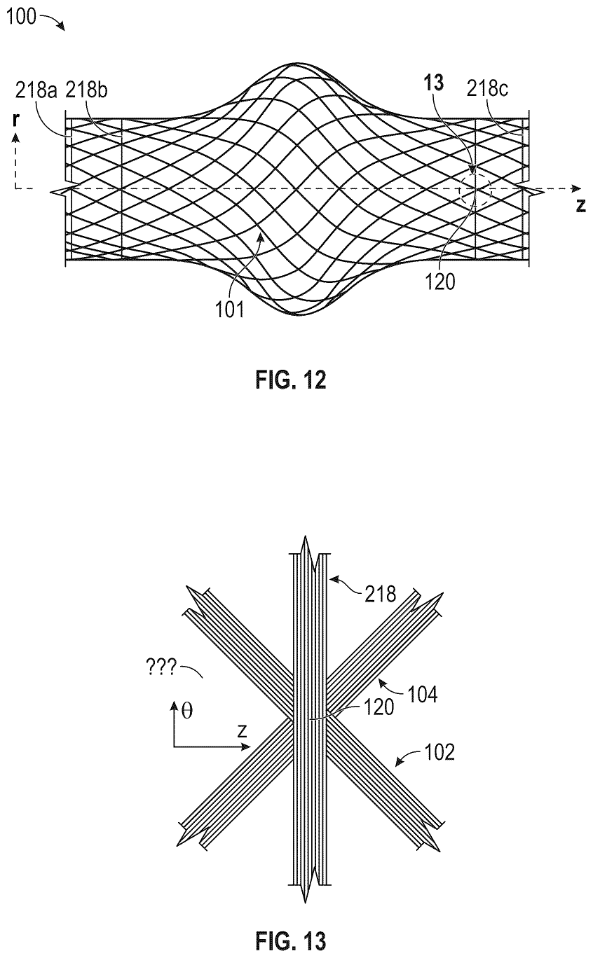

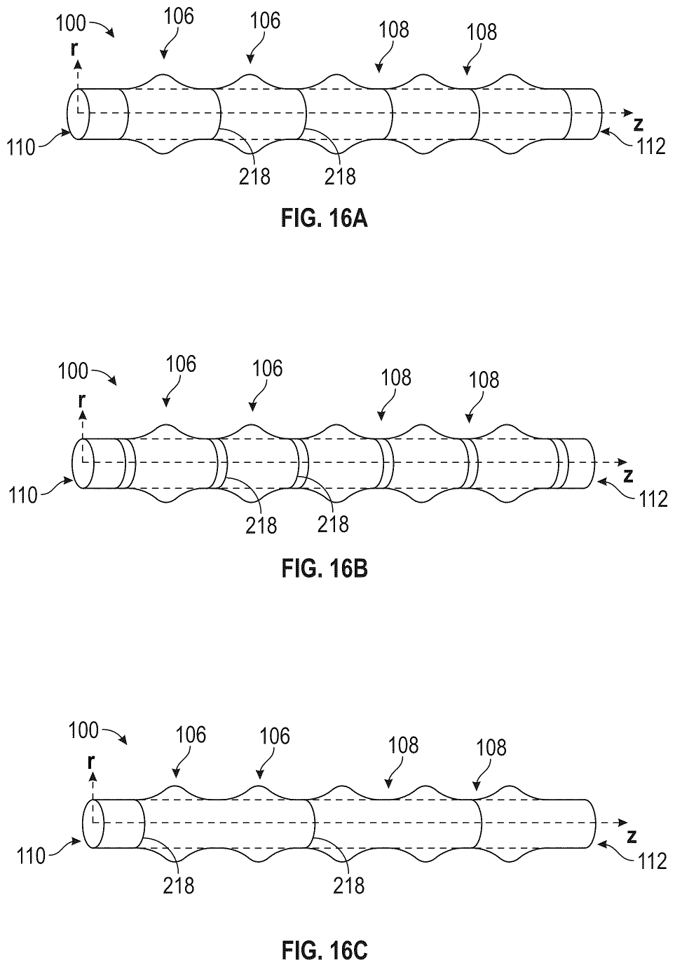

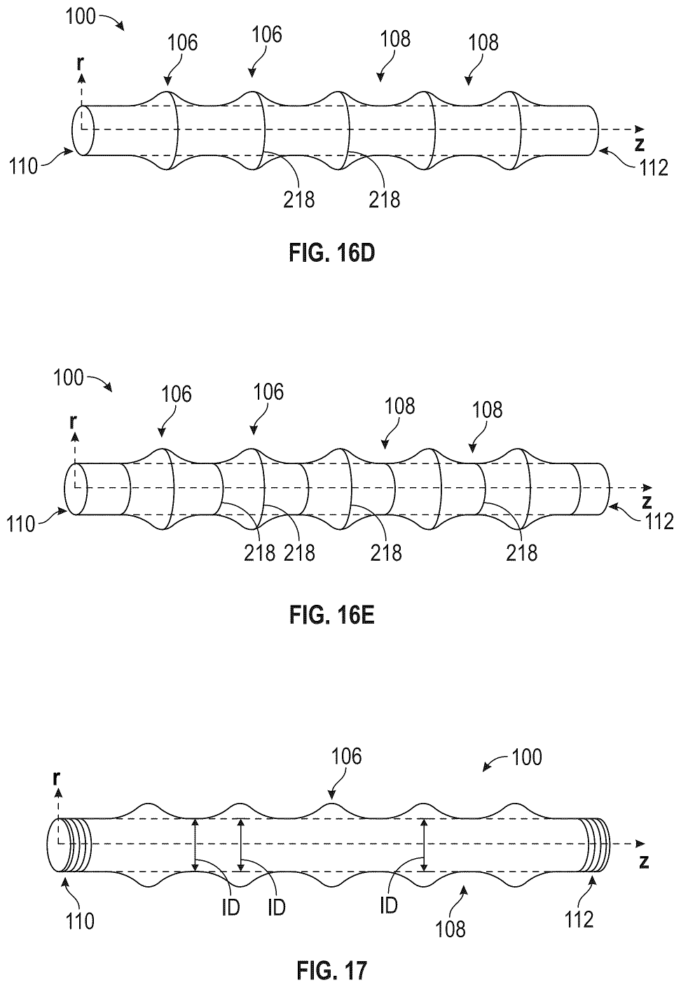

As shown in FIGS. 12-13, in some embodiments, the third group 218 of composite elements 101 can be arranged generally circumferentially (e.g., circumferentially or almost circumferentially) about the axis Z (e.g., in a hoop direction) axially spaced apart from one another along the axis Z such that individual composite elements 218a,b,c, . . . n form hoops around the shaft 100. The hoops of the composite elements 218a,b,c, . . . n can intersect the first and second groups 102, 104 at intersections 120. The hoops of the composite elements 218a,b,c, . . . n can be placed axially along the shaft 100 at regular, constant intervals or variable intervals (e.g., discussed further with respect to FIGS. 16A-16E).

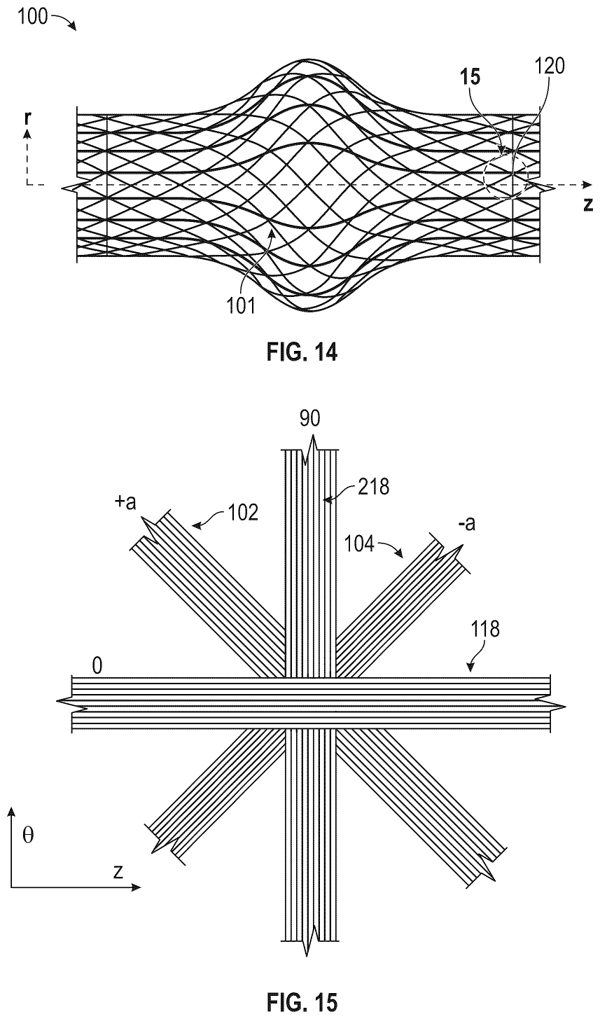

As shown in FIGS. 14-15, in some embodiments, the shaft 100 can include first and second groups 102, 104 of composite elements, and both axially oriented composite elements 118 as a third group of composite elements and hoops of composite elements 218 as a fourth group of composite elements. In such embodiments, each of the groups 102, 104, 118, 218 of composite elements 101 can intersect at a common point (e.g., respective intersections 120). In any of the embodiments shown in FIGS. 10-15, the individual composite elements of the first and second groups 102, 104, the axial strands 118, and the hoops of composite elements 218 can have a plurality of plies that can be overlaid, interleaved, or a combination of overlaid and interleaved and may include reinforcing pads 116 (FIG. 9C) of plies if desired. For example, any embodiment of overlay or weave as shown in FIGS. 9A-9C is possible for the embodiments of the shafts shown in FIGS. 10-15.

With reference now to FIGS. 16A-17, in some embodiments, the hoops of composite elements 218 (referred to as “hoops 218”) can be axially spaced apart from one another along the axis Z and positioned on the narrow portions 108 only. That is, in accordance with some embodiments, the hoops 218 may be arranged between the undulating portions 106 (e.g., FIGS. 16A-C). In other embodiments, the hoops 218 can be positioned on the undulating portions 106 only (e.g., FIG. 16D). In still other embodiments, the hoops 218 can be positioned on both the undulating portions 106 and the narrow portions 108 between the undulating portions 106 (e.g., FIG. 16E). In some embodiments, the hoops 218 can be placed at regular intervals or varying intervals along the axial length of the shaft 100. In some embodiments, more or additional hoops 218 can be included on the narrow portions 108 between the undulating portions 106 than on the undulating portions 106 (e.g., as shown in FIG. 16B). In some embodiments, only some narrow portions 108 can include hoops 218 (e.g., as shown in FIG. 16C). In some embodiments, the hoops 218 can be positioned or concentrated at the axial ends 110, 112 of the shaft (e.g., as shown in FIG. 17). In accordance with some embodiments, the hoops 218 (or the plies/elements thereof) may be embedded within the structure of the shaft 100 and/or the axial ends 110, 112 thereof.

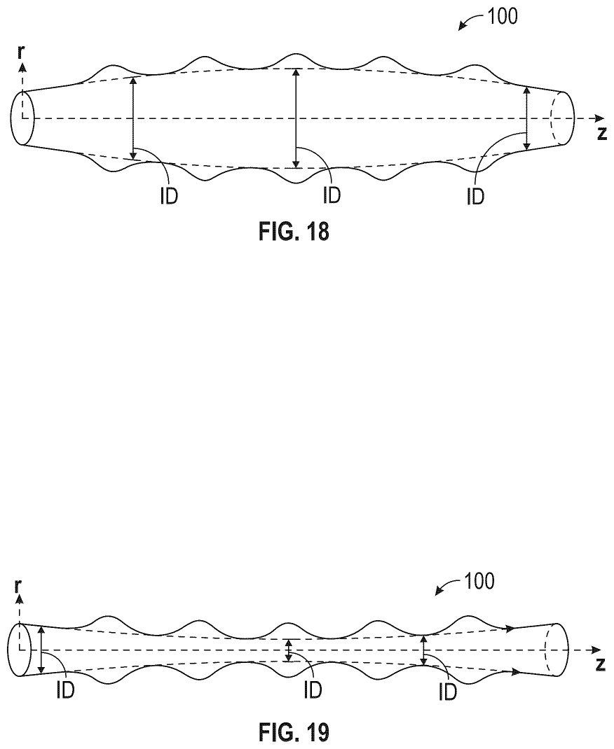

With reference now to FIGS. 17-20, in some embodiments, an axial cross-sectional profile of the hollow shaft 100 can be constant along the axial length of the shaft 100 (e.g., as shown in FIG. 17). In other embodiments, the axial cross-sectional profile of the hollow shaft can be convex along the axial length of the hollow shaft 100 (e.g., as shown in FIG. 18), with the shaft diverging or bowing toward a midpoint of the shaft and converging or tapering on the axial ends of the shaft. In still other embodiments, the axial cross-sectional profile of the hollow shaft can be concave along the axial length of the hollow shaft (e.g., as shown in FIG. 19), with the shaft converging or narrowing toward a midpoint of the shaft and diverging or widening at the axial ends of the shaft. The hollow shaft 100 can have a constant symmetric profile along the axis such that an inner diameter (ID) of the hollow shaft is cylindrical, as shown in FIG. 17 for example. the ID is measured between the narrow portions 108 (e.g., along the dotted line extending between ends 110 and 112). In some embodiments, the hollow shaft 100 can have a variable asymmetric profile along the axis such that the variable asymmetric cylindrical profile when viewed perpendicular to the axis is convex (e.g., FIG. 18) or concave (e.g., FIG. 19). In some such embodiments, the inner diameter ID of the hollow shaft 100 can vary along the axis as shown in FIGS. 18-19. In some embodiments, the hollow shaft 100 can be tubular.

In some embodiments, the plurality of composite elements 101 can include a plurality of individual composite elements oriented along respective axes of the individual composite elements. In certain embodiments, the individual composite elements can include unidirectional oriented fibers in a polymeric matrix to form a fiber-reinforced polymer-matrix composite. In some embodiments, the polymeric matrix composite can include a thermoset or a thermoplastic. The fiber-reinforced polymer-matrix composite can include the unidirectionally oriented fibers including any of carbon, glass and/or organic (e.g., Kevlar) fibers, for example. In accordance with some embodiments of the present disclosure, the various composite elements 101 may be bonded together or otherwise affixed together, such as during a curing process or the like. That is, in some embodiments, the intersections 120 may define locations of fixed connection between the different plies or composite elements. Such bonding between the layers may provide for increased structural rigidity to the shaft 100.

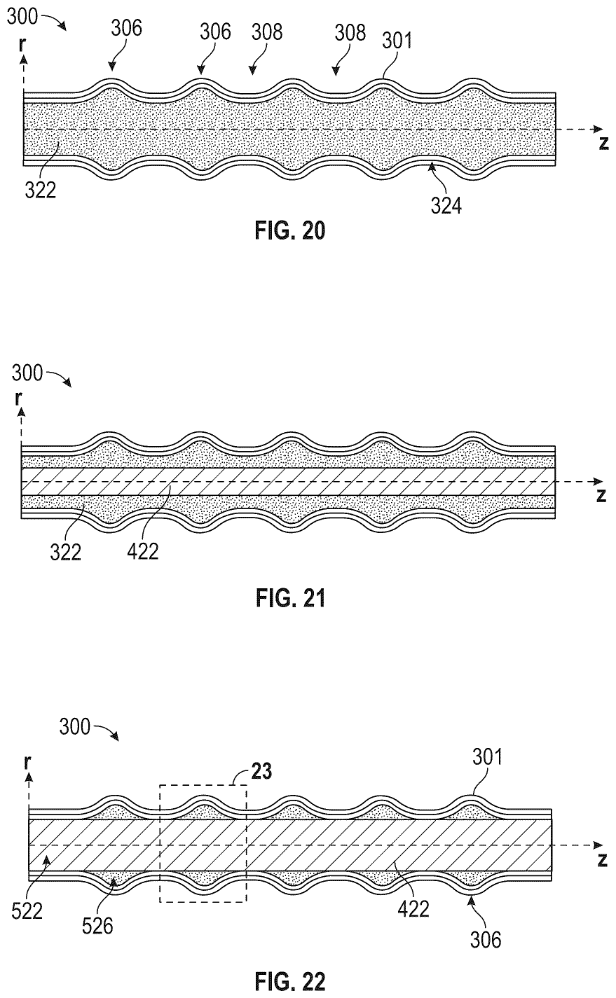

With reference to FIGS. 20-25, and in accordance with an embodiment of the present disclosure, a method 300 of making a composite shaft (e.g., any one of shafts 100 described herein) can include forming a mandrel 322 to have one or more undulating portions 306 and one or more narrow portions 308 between the plurality of undulating portions 306 along an axis Z of the mandrel 322. The method 300, in this embodiment, includes overlaying a composite web 301 onto an external surface 324 of the mandrel 322. Overlaying the composite web 301 onto the external surface 324 of the mandrel 322 can include placing a first plurality of individual composite elements (e.g., elements 102) in a first spiral orientation along the axis Z of the mandrel 322 in a first direction (e.g., clockwise), and placing a second plurality of individual elements (e.g., elements 104) in a second spiral orientation along the axis Z of the mandrel 322 in a second direction symmetric to but opposite from the first direction (e.g., counter clockwise). In accordance with some embodiments, the placement of the elements may be performed using automated fiber placement to form any one of the hollow shafts 100 described hereinabove. In other embodiments, winding or wrapping manufacturing operations may be performed to place the elements. In some embodiments, the method 300 can include embedding or placing one or more axial or circumferential elements (e.g., axial strands 118 and/or hoops 218) in or over the composite web 301 to reinforce the composite web 301 as needed for a given application.

The method 300 can then include hardening the composite web 301 on the mandrel 322. Hardening can include one or more of curing (e.g., for a thermoset polymeric matrix), solidifying (e.g., for a thermoplastic polymeric matrix), or otherwise hardening the web 301 based on the material of the web 301, as will be appreciated by those of skill in the art. The method 300 can further include removing the mandrel 322 from within the composite web 301 to leave behind the hollow shaft (e.g., any embodiment of hollow shaft 100 as described herein).

As shown in FIG. 20, forming the mandrel 322 can include forming the mandrel 322 from a washable material to have the one or more undulating portions 306. In such embodiments, removing the mandrel 322 can include applying a fluid to the washable mandrel 322 to dissolve the washable mandrel 322 to leave behind the hollow shaft 100 (i.e., the composite web 301). Removing the mandrel 322 can be completed after hardening the composite web 301. In accordance with a non-limiting example, the washable mandrel 322 can be formed from salt, and the fluid used to wash away the mandrel 322 can be water. However, it will be appreciated that any suitable washable material may be used for the mandrel 322 with a corresponding washing fluid, without departing from the scope of the present disclosure.

With respect to removing washable mandrels and/or inserts, in accordance with embodiments of the present disclosure, a fluid may be applied to wash out the material of the respective washable mandrels and/or inserts. In some non-limiting examples, the liquid may be water, although other suitable materials may be used without departing from the scope of the present disclosure. For example, in some configurations, the liquid used for the washing may be based on the material used to make up the structure of the washable mandrels and/or inserts. During a washing operation, the fabricated structure (i.e., the washable mandrels and/or inserts) may be kept in a tank filled with the liquid, with or without changing the position of the assembly during the washing-out process. In some non-limiting embodiments, a change of position of the assembly in the tank may be performed periodically. For example, and without limitation, the position, orientation, rotation, movement, and the like, of the assembly may be adjusted at uniform or non-uniform intervals, or permanently, for example by applying rotation. In other embodiments, a directed stream of the liquid may be applied to accelerate the washing-out process. For example, at the end of the process duration additional forced liquid (e.g., directed stream) may be applied or employed to remove portions of the washable materials in certain local areas that may not have been removed during the prior washing process(es).

In some embodiments, the applied fluid (i.e., washing fluid) may be kept at elevated temperature, such as above ambient room temperature. In some embodiments, the elevated temperature may be within a range of +35C and +95C deg. In other embodiments, the elevated temperature may be within +50C and +70C deg. In some embodiments, the temperature of the washing fluid may be kept constant or approximately constant (e.g., within ±10C deg of variation). In other embodiments, for example, the temperature of the washing fluid may be nonuniform but maintained within specified lower and higher boundaries of variation. The duration of applying the washing liquid to wash out the temporary mandrels and/or inserts may depend on the volume of the washable materials, the total contact surface, the geometry of fabricated coupling structure(s), the temperature of the washing liquid, the chemistry of the washing liquid and associated properties, the chemistry and properties of the washable materials, and other parameters of the washing-out process. The parameters of the washing-out process and its duration may be defined according to modeling predictions, observations of available empirical data, combinations thereof, and the like. The parameters and duration may be further refined or optimized according to any of cost, quality, timing or other relevant considerations, as will be appreciated by those of skill in the art.

In some embodiments, such as shown in FIG. 21, forming a mandrel 322 can include forming the washable mandrel 322 to have the one or more undulating portions 306 over a metallic cylindrical sub-mandrel 422. In such embodiments, removing the mandrel 322 can include removing the metallic cylindrical sub-mandrel 422 from the washable mandrel 322 first, then applying the washing fluid to the washable mandrel 322 to dissolve the mandrel 322 to leave behind the hollow shaft 100. In other embodiments, the washable mandrel 322 may be removed before the metallic sub-mandrel 422.

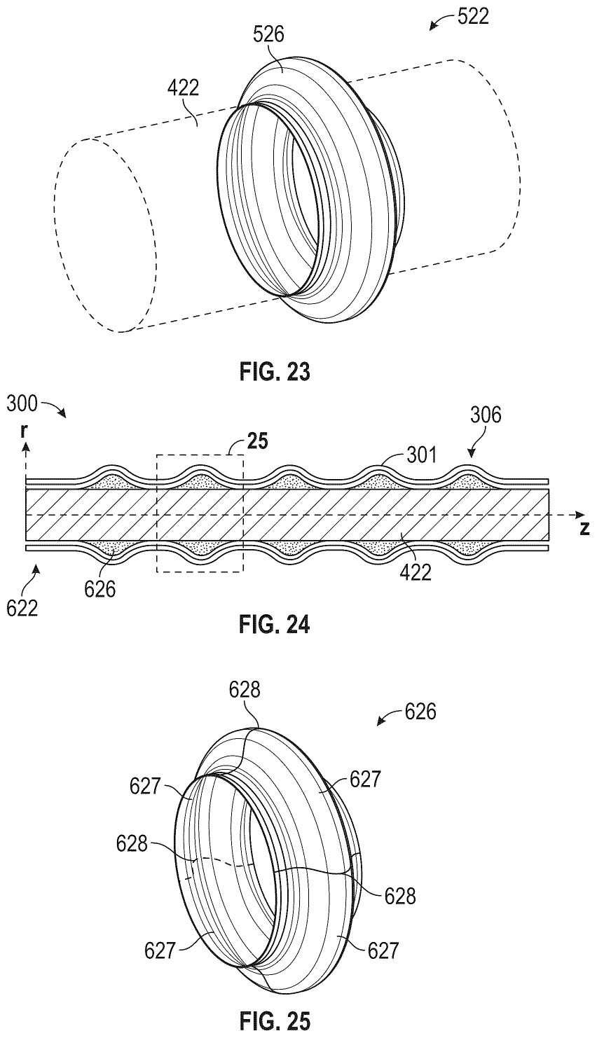

In some embodiments, for example as shown in FIGS. 22-23, forming a mandrel 522 can include installing a plurality of washable rings 526 to a metallic cylindrical sub-mandrel 422 to form the one or more undulating portions 306. In such embodiments, removing the mandrel 522 can include removing the metallic cylindrical sub-mandrel 422 from the washable rings 526, and then applying the washing fluid to the washable rings 526 to dissolve the washable rings 526 to leave behind the hollow shaft 100. In certain embodiments, the washable rings 526 can be removed before the metallic sub-mandrel 422.

In some embodiments, such as shown in FIGS. 24-25, forming the mandrel 622 can include installing a plurality of circumferentially segmented rings 626 to a metallic cylindrical sub-mandrel 422 to form the one or more undulating portions 306. The segmented rings 626 can be comprised of segments 627 connected along the circumferential orientation by creating closed-loop rings, where the segments 627 are joined to one another at respective joints 628. In some such embodiments, removing the mandrel 622 can include removing the metallic cylindrical sub-mandrel 422 from the segmented rings 626, and disassembling the segments 627 of the segmented rings 626 to leave behind the hollow shaft 100. The segmented rings 626 can then be reused for forming another mandrel 622.

Drive shafts are typically expected to deliver two structural requirements: a) to be very stiff and strong under torque, but also b) to be very flexible under bending and/or axial deformations. To satisfy these requirements, conventional drive shafts typically include a combination of a flexible axisymmetric diaphragm and a cylindrical tube (drive shaft body). The diaphragm is usually an axisymmetric thin-wall mechanism working as a “spring” under bending/axial loads but still very stiff under torque due to its circular shape. Along with structural efficiency of conventional diaphragms, conventional drive shafts can have a relatively high cost of manufacture, a time-consuming fabrication process, high requirements for quality, require parts for machining in advance, and potential damage to weaker portions of the shaft. In addition, conventional diaphragms can require additional space in the radial direction, resulting in the drive shaft body having smaller diameter due to limited available space and to accommodate the diaphragms. This can reduce the structural efficiency of the shaft, especially with respect to strength and vibrational responses.

Some embodiments of the present disclosure are directed to “diaphragm-less” drive shaft systems and methods of making such integrated shaft-coupling flexible composite drive systems (e.g., as shown in FIGS. 1-8) to address, at least, the limitations and/or drawbacks of conventional drive shaft configurations. Embodiments of a drive shaft (e.g., shaft 100) can include +α/−α mesh-type composite web with radially outward undulations. The web can be a combination of a plurality of spiral composite elements positioned under angle “+α” and a plurality of spiral composite elements positioned under angle “−α”. In addition, the web can have a geometrical shape of a hollow cylinder with at least one axisymmetric radially outward undulation. In some embodiments, individual composite spiral elements of each plurality of composite elements are placed with gaps between the composite elements. In accordance with some embodiments, drive shafts of the present disclosure may be made from advanced fiber-reinforced composite materials. Embodiments of the drive shafts and methods of making the drive shafts can overcome the challenges faced by conventional shafts (e.g., with separate mechanical couplings as discussed above).

In some embodiments, an axial cross-sectional shape of the undulations can include a convex section, two concave sections and, optionally, linear or curved connecting sections between them. In embodiments, the axial cross-sectional shapes of the undulations can be symmetric or asymmetric and the undulations can be the same or different along the axial direction. In some embodiments, the undulating portions can be included along an entire axial length of the shaft. In some embodiments, the undulating portions can be positioned adjacent to one another so that one undulating portion connects to an adjacent undulation portion with no flat or narrow portions in between. In some embodiments, the undulating portions can be concentrated at the axial ends of the hollow shaft and a flat or narrow portion can be defined between the end-located undulating portions. In some embodiments, the undulating portions can be concentrated at a center of the shaft such that the axial ends of the shaft are free of undulating portions. In some such embodiments, a central undulation or set of undulations is provided with narrow portions extending axially therefrom to the axial ends of the shaft. The undulating portions can be axisymmetric. In some embodiments, the undulating portions can have varying geometries and/or sizes from one another. In some embodiments, the undulating portions can be disposed along the shaft at regular or variable intervals.

The angles “α” can be within 30° and 60° with respect to the shaft axial direction. In some embodiments, the angle α may be 45°. In accordance with some embodiments, the composite webs formed from composite elements can have low-density, high-density, or a combination of low-density sections and high-density sections, such as shown in FIGS. 5-6. The density indicates a number of individual composite spiral elements per unit width. In some embodiments, a very high density (e.g., as in FIG. 6) of composite elements may be arranged such that the formed web can be as a continuous shell in areas outside the undulation(s) (e.g., narrow portions), and a lower density of composite elements may be provided within the undulation portions.

FIGS. 4A-4B show schematic cross-sectional views of deformation of a drive shaft in accordance with an embodiment of the present disclosure, as deformed under axial tension (FIG. 4A) and compression (FIG. 4B). These illustrations of FIGS. 4A-4B demonstrate a desired axial flexibility achieved due to radial deformation, i.e., radial “shrinking” under axial tension or radial expansion under axial compression. Advantageously, this axial flexibility may provide bending flexibility as well.

As shown in FIGS. 9A-9C, corresponding periodic joints between spiral composite elements are illustrated. For example, FIG. 9A illustrates a configuration without interconnection of individual plies of different spiral elements, FIG. 9B illustrates such interconnection between individual plies of different spiral elements, and FIG. 9C illustrates a configuration with finite-length reinforcing pads. At the locations of overlap between the individual plies or layers of the spiral elements, the plies/layers may be bonded or otherwise affixed together to create a substantially fixed joint or connection.

Some embodiments of the present disclosure can include additional reinforcement in the axial direction, where individual axial composite elements follow the overall shape of a shaft with undulations (e.g., FIGS. 10-11) to keep noted benefits of axial flexibility (e.g., as described with respect to FIGS. 4A-4B). In some embodiments, a plurality of composite elements can be distributed in the hoop direction (FIGS. 12-13) relative to the shaft. These axial and/or hoop composite elements can be interconnected with the spiral elements. That is, the axial and/or hoop composite elements may bond with the spiral composite elements to form fixed or bonded intersections between the composite elements. In accordance with some embodiments, hoop elements may be provided and arranged at various locations axial locations along the shaft. For example, and without limitation, the hoop elements may be arranged on, in, or with the undulations, or between the undulations, at the diametric tips of undulations or combinations thereof, (e.g., FIGS. 16A-16E). In some embodiments, if both axial and hoop reinforcement elements are implemented in addition to the spiral elements, the various elements can all be interconnected together at intersection locations between two or more of the elements.

In accordance with some embodiments, an additional and/or optional reinforcement can be provided at ends of the shaft (e.g., as shown in FIG. 17). The reinforcement in these areas may be provided for extra reinforcement for connections with outside flanges and/or other components that attach to the drive shaft. This additional reinforcement may also be provided for reliable embedding of corresponding ends of spiral and, if applicable, axial composite elements. Reinforcement of the ends can include additional composite plies oriented in any of 0° (axial), 90° (hoop), or “+b” or “−b” (angular) orientations with respect to the axial direction, for example. Such angles “b” can be the same as angles “a” or the non-axial, non-hoop angles may be different.

As illustrated and described herein, some embodiments can employ complex shapes of drive shafts with undulations. For example, and without limitation, the undulations can be applied to a convex shaft geometry (e.g., FIG. 18) or a concave shaft geometry (e.g., FIG. 19). Such profiles can be useful for, for example, optimization of buckling and/or vibrational behaviors of drive shafts.

With respect to methods of making drive shafts, embodiments of the present disclosure can be applied to fiber-reinforced polymer-matrix materials. Some such material may include, for example and without limitation, fibers of carbon, glass, and/or organic (e.g., Kevlar) materials or combinations thereof. A polymeric matrix used for drive shafts of the present disclosure can be or include, for example, thermoplastic or thermoset. Strength and stiffness of fiber reinforcement can be achieved by arranging uni-directional fibers in alignment along corresponding individual orientations of spiral, axial, and hoop components elements. In some embodiments, fabrication of a composite web can be performed by Automated Fiber Placement (AFP). However, it will be appreciated that any other suitable fiber placement may be employed, such as filament-winding or fiber braiding applications.

In accordance with some embodiments (e.g., FIG. 20) of a method of manufacture of the present disclosure, a washable temporary mandrel may be used. In such manufacturing processes, an outside surface of the mandrel may correspond to an inside surface of a composite web that is wrapped about or otherwise applied to the outside surface of the mandrel. The web can be applied on the top of the outside surface of the mandrel, and upon completion of the web fabrication, the mandrel may be removed by washing or other removal process, as will be appreciated by those of skill in the art.

In some embodiments (e.g., FIG. 21), the washable mandrel may have a complex shape that can also include an insert in the form of metallic cylindrical element. The metallic cylindrical element (e.g., sub-mandrel) can provide additional strength and stiffness during fabrication. The metallic cylindrical element (e.g., sub-mandrel) can also be repeatedly used for fabrication of multiple shafts with benefits of manufacturing cost reduction due to smaller volume/amount of washable material.

In some embodiments, (e.g., FIGS. 22-23) the mandrel system may include a metallic cylinder (sub-mandrel) defining an inner diameter of a shaft and plurality of washable ring-type temporary mandrels applied to the sub-mandrel for defining and forming individual undulations on the formed drive shaft. In another embodiment, (e.g., FIGS. 24-25) a solid insert can be used as a ring-type mandrel instead of washable material to define the undulations of the formed drive shaft. Such mandrels can be implemented as a combination of separate segments joined together to create a ring-type part (FIG. 25). The segments can be assembled by joints to create a ring-type mandrel before fabrication of the composite web. The segmented rings can be re-assembled and removed after the web fabrication. The re-assembling process can be performed through gaps between spiral elements. Different variations of temporary joining solutions between the segments can be used depending on materials, number of segments, cost restrictions, etc. A representative example of a joining solution can be a bolting connection making both assembling and re-assembling fast and simple. Any combination of methods of manufacture described herein can be suitable for any one or more of the drive shafts described herein. Moreover, any one or more elements of the embodiments of the drive shafts included can be combined with other embodiments of drive shafts and methods of manufacture as needed to achieve desired properties of the drive shaft.

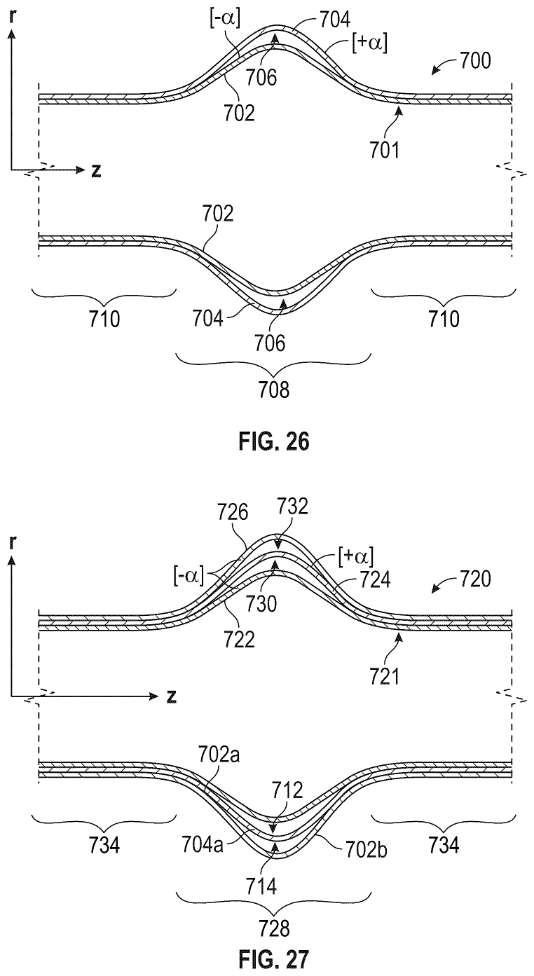

Referring now to FIG. 26, a schematic illustration of a portion of a composite shaft 700 in accordance with an embodiment of the present disclosure is shown. The composite shaft 700 may be similar to that as described above. For example, as illustratively shown, the composite shaft 700 includes a first group 702 of composite elements 701 and a second group 704 of composite elements 701. The first group 702 of the composite elements 701 are arranged about an axis Z and are offset by or oriented at an angle +α and the second group 704 of the composite elements 701 are arranged about the axis Z and are offset by or oriented at an angle −α to form a web with the first group 702 of composite elements 701.

As discussed above, in various embodiments, the different composite elements may be bonded or otherwise joined together at locations where the composite elements overlap between the two sets/groups. However, such fixed connection may not be necessary, especially along the entire axial length of the composite shaft. For example, as shown in FIG. 26, a gap 706 may be defined between the first group 702 of the composite elements 701 and the second group 704 of the composite elements 701 at the location of an undulating portion 708 of the composite shaft 700. As a result, in the undulating portion 708, the different layers of the groups 702, 704 of the composite elements 701 may not be bonded together, but rather are intentionally separated by the gap 706 during the manufacturing process, as described herein. Once formed, the gaps 706 will be present in a final, cured or fully processed composite shaft 700. It will be appreciated that the gaps 706 may not extend the full axial length of the undulating portion 708, but rather may define some shorter or smaller axial length along the undulating portion 708. For example, and without limitation, some axial length (e.g., at least 20%) along the undulating portion 708, such as centered on an apex of the undulation or the like, may be provided with the gap 706, and the rest of the composite elements axially outward from the portion with the gap 706 along the undulating portion 708 may include bonded, fused, or joined composite elements. In still other embodiments, multiple short axial lengths along the undulating portion may be provided, with bands or axial length sections having bonded, fused, or joined composite elements between sections or portions that have gaps and thus are unbonded and free to move independently of each other when the composite shaft is under load. As such, the illustrative axial lengths of the gaps is not intended to be limiting, but rather is provided for illustrative and explanatory purposes.

As a result, during tension or compression, the composite shaft 700 may have improved flexibility to accommodate various forces applied to the composite shaft 700 during operation in a machine or system. In this illustrative example, the different layers of the groups 702, 704 of the composite elements 701 may be bonded together along narrow portions 710 of the composite shaft 700. As such, in some such embodiments, the groups 702, 704 of the composite elements 701 may be partially bonded together (e.g., along the narrow portions 710) and partially separated from each other (e.g., along the undulating portions 708). Accordingly, the composite shaft 700 is formed of sets or groups of composite elements that are unconnected to each other, with gaps 706 defined in a radial direction relative to the axis Z between the groups 702, 704 of composite elements 701.

Referring now to FIG. 27, a schematic illustration of a portion of a composite shaft 720 in accordance with an embodiment of the present disclosure is shown. The composite shaft 720 may be similar to that as described above. For example, as illustratively shown, the composite shaft 720 includes a first group 722 of composite elements 721, a second group 724 of composite elements 721, and a third group 726 of composite elements 721. The first group 722 and the third group 726 of the composite elements 721 are arranged about an axis Z and are offset by or oriented at an angle +α and the second group 724 of the composite elements 721 are arranged about the axis Z and are offset by or oriented at an angle −α to form a web with the first and third groups 722, 726 of composite elements 721.

Similar to the configuration of FIG. 26, along undulating portions 728, the groups 722, 724, 726 are not bonded together, but rather are separated by gaps 730, 732. Further, similar to the configuration of FIG. 26, the groups 722, 724, 726 are bonded together along narrow portions 734. In this configuration, however, there are two groups 722, 726 of composite elements 721 that are arranged at angle +α and one group 724 of composite elements 721 arranged angle −α. Between the first group 722 of composite elements 721 and the second group 724 of composite elements 721 is a first gap 730 defined along the undulating portion 728. Between the second group 724 of composite elements 721 and the third group 722 of composite elements 721 is a second gap 732 defined along the undulating portion 728. The gaps 730, 732 are provided to prevent bonding or fixed connection between the composite elements 721 of the various groups 722, 724, 726 along the undulating portion 728. However, along the narrow portions 734 of the composite shaft 720, the various groups 722, 724, 726 are joined or bonded together to define substantially rigid or fixed sections of the composite shaft 720.

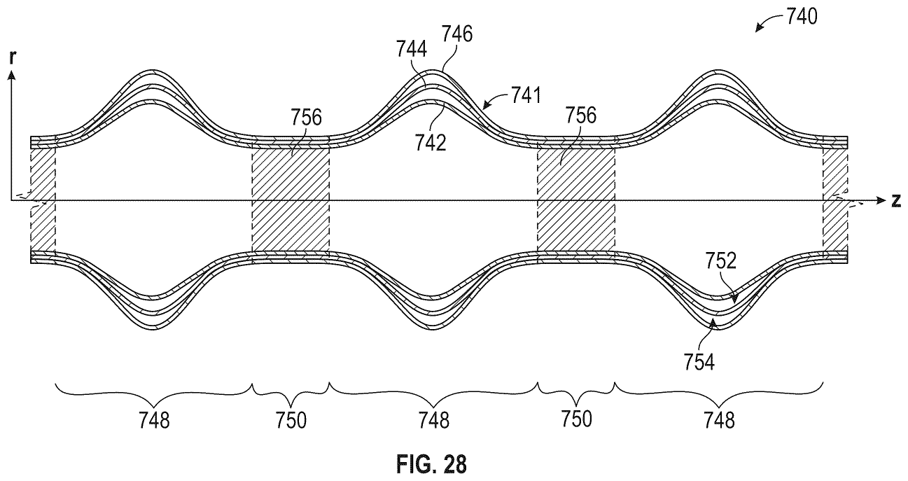

Referring now to FIG. 28, a schematic illustration of a portion of a composite shaft 740 in accordance with an embodiment of the present disclosure is shown. The composite shaft 740 may be similar to that as described above. For example, as illustratively shown, the composite shaft 740 includes a first group 742 of composite elements 741, a second group 744 of composite elements 741, and a third group 746 of composite elements 741, similar to the configuration of FIG. 27. The first group 742 and the third group 746 of the composite elements 741 are arranged about an axis Z and are offset by or oriented at an angle +α and the second group 744 of the composite elements 741 are arranged about the axis Z and are offset by or oriented at an angle −α to form a web with the first and third groups 742, 746 of composite elements 741.

The composite shaft 740 shown in FIG. 28 includes a number of undulating portions 748 with narrow portions 750 defined between axially adjacent undulating portions 748. Within the undulating portions 748, gaps 752, 754 are defined between the groups 742, 744, 746. For example, as shown, within the undulating portions 748, a first gap 752 (radial direction) is defined between the first group 742 of composite elements 741 and the second group 744 of composite elements 741. Further, within the undulating portions 748, a second gap 754 (radial direction) is defined between the second group 744 of composite elements 741 and the third group 746 of composite elements 741. In this configuration, the narrow portions 750 may include reinforcement elements 756. The reinforcement elements 756 may be formed of circumferentially arranged or hoop-oriented composite elements, similar to that shown and described above (e.g., FIGS. 12, 14, 16A-16E).

It will be appreciated that the reinforcement elements may be arranged at any orientation including, but not limited to, circumferentially (hoop), axially, or arranged at a non-zero angle relative to an axis through the shaft, such as at an angle β, which may be the same or different from the angle α of the composite elements. In some embodiments, the reinforcement elements maybe wound or wrapped in a similar arrangement as the composite elements, but at a different angle (β) than the angle α of the composite elements. The reinforcement elements may be formed of similar material as the composite elements or may be made from materials different than that of the composite elements.

In the embodiments of FIGS. 26-28, the composite shafts 700, 720, 740 are formed with gaps within the undulating portions between the groups or layers of composite elements. The gaps may be substantially uniform in radially dimension at the center/peak of the undulating portions, with the gaps narrowing in the axial direction (both positive and negative) toward adjacent narrow portions.

In embodiments that include three layers (e.g., FIGS. 27-28), the central layer of composite elements (e.g., group 724, 744) may be sized to be about twice the radial thickness as one of the layers of the other two layers (e.g., one layer of groups 722, 726, 742, 746). As a result, the thickness of the composite elements that are oriented in the angle +α is about equal to the thickness of the composite elements that are oriented in the angle −α. In some such embodiments, the central layer (e.g., defined by group 724, 744) may be formed from two layers of composite elements stacked on top of each other, or may be formed as a single larger or thicker layer of composite elements. In embodiments that have the central layer formed from two stacked thinner layers, the end result is a single layer having a double thickness due to the curing or other treatment prior to finalization, where the locations of contact between composite elements will be bonded together, as described above.

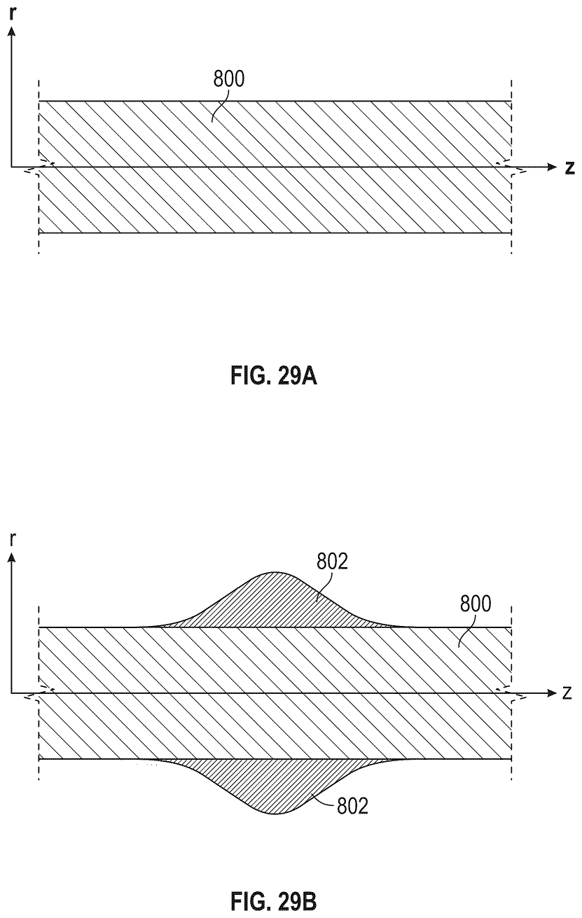

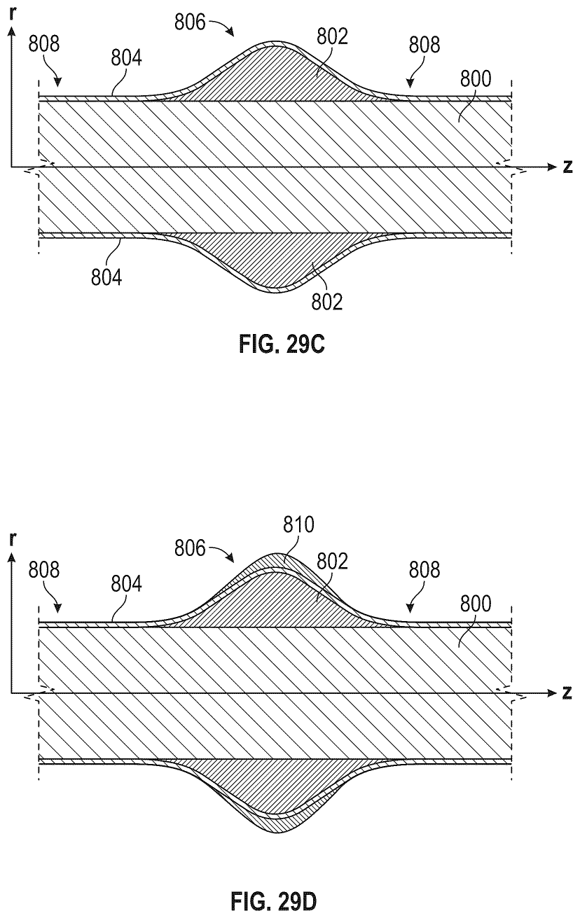

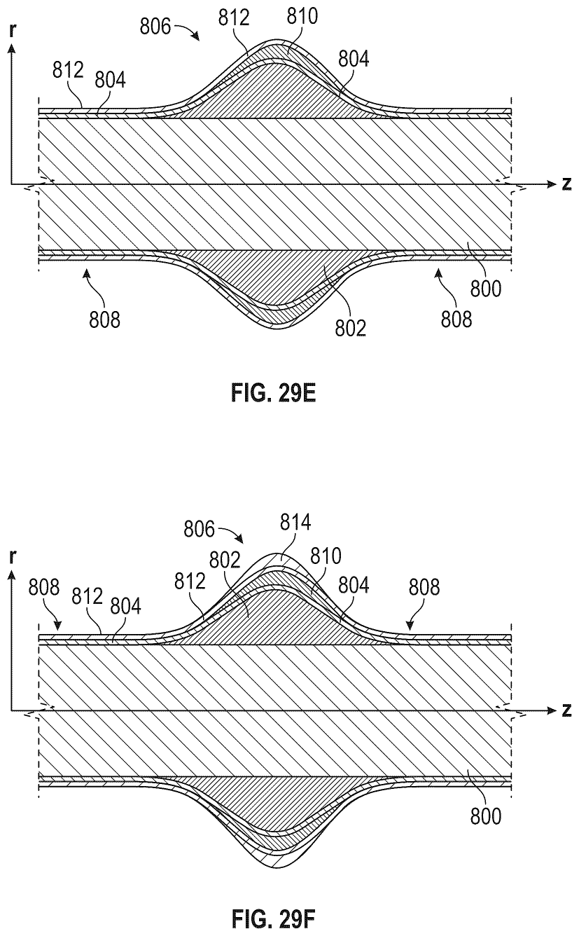

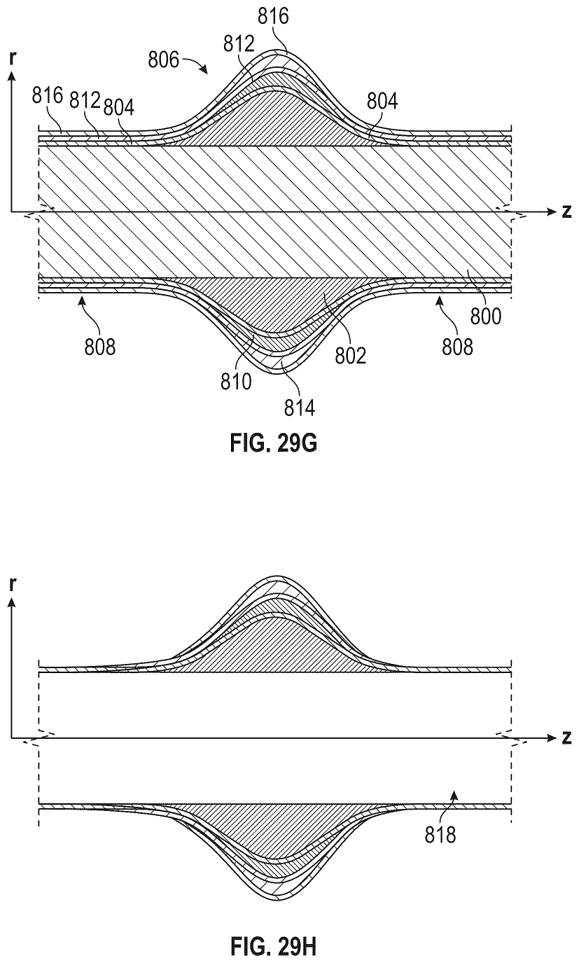

Referring now to FIGS. 29A-29I, a method of manufacturing a composite shaft in accordance with an embodiment of the present disclosure is shown. FIGS. 29A-29I illustrate the manufacturing process. In FIG. 29A, a mandrel 800 is provided. The mandrel 800 may be similar to the mandrels shown and described above. In this embodiment, the mandrel 800 is similar to the configuration shown and described with respect to FIG. 22, although other mandrel configurations may be employed without departing from the scope of the present disclosure. The mandrel 800 maybe formed from a washable material, as described above.

In FIG. 29B of the method of manufacture, a first washable insert 802 is installed to the mandrel 800. The first washable insert 802 may be similar to the similar structures shown and described above. For example, and without limitation, the first washable insert 802 may be a washable ring (e.g., similar to FIG. 23), a segmented washable ring (e.g., similar FIG. 25), or other structure that may be installed on the mandrel 800.

At the next step, shown in FIG. 29C, a first composite layer 804 is applied to or installed on the mandrel 800 and the first washable insert 802. The first composite layer 804 may be formed from a plurality of wrapped, wound, or placed composite strands or composite elements, similar to that shown and described above. The composite elements of the first composite layer 804 may be arranged or oriented at a first angle (e.g., angle +α). As the first composite layer 804 is applied to the mandrel 800 and the first washable insert 802, an undulating portion 806 will be defined at the locations where the first composite layer 804 extends over or along the first washable insert 802. Axially along the assembly, narrow portions 808 are defined between or adjacent to undulating portions, as shown and described above. The first composite layer 804 is thus applied to or in contact with surfaces of the mandrel 800 along the narrow portion 808 and applied to or in contact with surfaces of the first washable insert 802 along the undulating portion 806.

At the next step, shown in FIG. 29D, a second washable insert 810 is installed on top of the first composite layer 804 for the axial extent of the undulating portion 806. Stated another way, the second washable insert 810 is installed at the same axial position as the first washable insert 802, but arranged radially outward therefrom, with material of the first composite layer 804 positioned between the first washable insert 802 and the second washable insert 810. In this configuration, the second washable insert 810 does not extend axially beyond the undulating portion 806, or stated another way, the second washable insert 810 does not extend axially into or along the narrow portions 808. Further, in accordance with some embodiments, the axial length of the second washable insert 810 may be less than the axial length of the first washable insert 802. This tapering in length of the washable inserts may be provided to ensure that the curvature of the applied composite layers is smooth to form an undulation along the composite shaft.

At the next step, shown in FIG. 29E, a second composite layer 812 is applied to or installed on the first composite layer 804 (axially along the narrow portions 808) and the second washable insert 802 (axially along the undulating portion 806). The second composite layer 812 may be formed from a plurality of wrapped, wound, or placed composite strands or composite elements, similar to that shown and described above. The composite elements of the second composite layer 812 may be arranged or oriented at a second angle (e.g., angle −α). As the second composite layer 812 is applied to the assembly, the undulating portion 806 will increase in radial dimension due to the first washable insert 802. A gap or space is formed between the first composite layer 804 and the second composite layer 812 that is defined by the first washable insert 802. Axially along the assembly, the narrow portions 808 will also increase in radially thickness, but only as much as the stacked first composite layer 804 and the second composite layer 812, as no insert or other spacing/separating structure is provided therebetween. The second composite layer 812, as applied or installed, will be in contact with surfaces of the first composite layer 804 along the narrow portion 808 and applied to or in contact with surfaces of the second washable insert 810 along the undulating portion 806.

At the next step, shown in FIG. 29F, a third washable insert 814 is installed on top of the second composite layer 812 for the axial extent of the undulating portion 806. Stated another way, the third washable insert 814 is installed at the same axial position as the first washable insert 802 and the second washable insert 810, but arranged radially outward therefrom, with material of the second composite layer 812 positioned between the second washable insert 810 and the third washable insert 814. In this configuration, the third washable insert 814 does not extend axially beyond the undulating portion 806, or stated another way, the third washable insert 814 does not extend axially into or along the narrow portions 808. Further, in accordance with some embodiments, the axial length of the third washable insert 814 may be less than the axial length of the second washable insert 810.

At the next step, shown in FIG. 29G, a third composite layer 816 is applied to or installed on the second composite layer 812 (axially along the narrow portions 808) and the third washable insert 814 (axially along the undulating portion 806). The third composite layer 816 may be formed from a plurality of wrapped, wound, or placed composite strands or composite elements, similar to that shown and described above. The composite elements of the third composite layer 816 may be arranged or oriented at the first angle (e.g., angle +α) similar to the first composite layer 804, or may be arranged at a third angle that is different from the first and second angles. As the third composite layer 816 is applied to the assembly, the undulating portion 806 will increase in radial dimension due to the washable inserts 802, 810, 814 and the other composite layers 804. 812. A gap or space is formed between the third composite layer 816 and the second composite layer 812 that is defined by the second washable insert 814. Axially along the assembly, the narrow portions 808 will also increase in radially thickness, but only as much as the stacked composite layers 804, 812, 816 as no insert or other spacing/separating structure is provided therebetween. The third composite layer 814, as applied or installed, will be in contact with surfaces of the second composite layer 812 along the narrow portion 808 and applied to or in contact with surfaces of the third washable insert 814 along the undulating portion 806.

At the next (optional) step, the assembly (shown in FIG. 29G) may be cured, if appropriate, depending on the nature, material selection, and properties of the composite materials used to form the composite layers 804, 812, 816. The material of the composite layers 804, 812, 816 will bond or join together along the narrow portions 808, where the material of the composite layers 804, 812, 816 is arranged in contact with each other. In some embodiments, hoop composite elements and/or axial composite elements may be added or applied, as described above. With the composite layers 804, 812, 816 hardened or otherwise treated to form a composite shaft, the supporting manufacturing elements (e.g., mandrel 800 and inserts 802, 810, 814) may be removed.

For example, as shown in FIG. 29H, the mandrel 800 is removed and a central bore 818 is defined within the assembly. The mandrel 800 may be washed out, if configured as a washable mandrel. In other embodiments, the mandrel 800 may be a cylindrical metal structure which may be removed before a washing operation is performed, such as shown and described above.

Referring to FIG. 29I, a composite shaft 820 is formed after removal of the mandrel 800 and the inserts 802, 810, 814. The removal of the mandrel 800 and the inserts 802, 810, 814 may be performed by a washing operation, although other mechanisms for removing mandrels and the inserts 802, 810, 814 may be employed without departing from the scope of the present disclosure. The composite shaft 820 has a central bore 818 defined radially inward from an inner surface of the first composite layer 804. Radially outward from the first composite layer 804 is the second composite layer 812, and radially outward from the second composite layer 812 is the third composite layer 816. The layers 804, 812, 816 may be fixedly attached, connected, or joined together at locations of overlap (e.g., junctions) between individual layers or elements of the respective composite layers 804, 812, 816, such as along the narrow portions 808 of the composite shaft 820. At the locations of the undulating portions 806, the individual composite layers 804, 812, 816 are not connected or otherwise attached to each other (in a radial direction) due to the inclusion of the inserts 802, 810, 814 used during the manufacturing process described above. When the second and third inserts 810, 814 are removed, respective gaps 822, 824 are defined between the first and second composite layers 804, 812 and between the second and third composite layers 812, 816, respectively.

In accordance with embodiments of the present disclosure, the inclusion of the gaps between the composite layers, particularly at the undulating portions of the composite shafts, may increase the relatively flexibility of the composite shaft relative to axial and bending moment forces, while maintaining stiff and strong structural properties when subject to an applied torque. The gaps may be provided and formed to reduce or eliminate contact stresses between the composite layers. For example, the gaps can enable mutual deformation composite elements easier under an applied load. Accordingly, the gaps may increase and/or improve overall flexibility under bending and/or axial loads. In accordance with some embodiments, the second composite layer 812, which is sandwiched between the first composite layer 804 and the third composite layer 816, may have a thickness that is about twice the thickness of the first and third composite layers 804, 816 individually. That is, the second composite layer 812 may be twice the thickness of the first composite layer 804 or twice the thickness of the third composite layer 816. In some embodiments, the first and third composite layers 804, 816 may have substantially the same thickness.

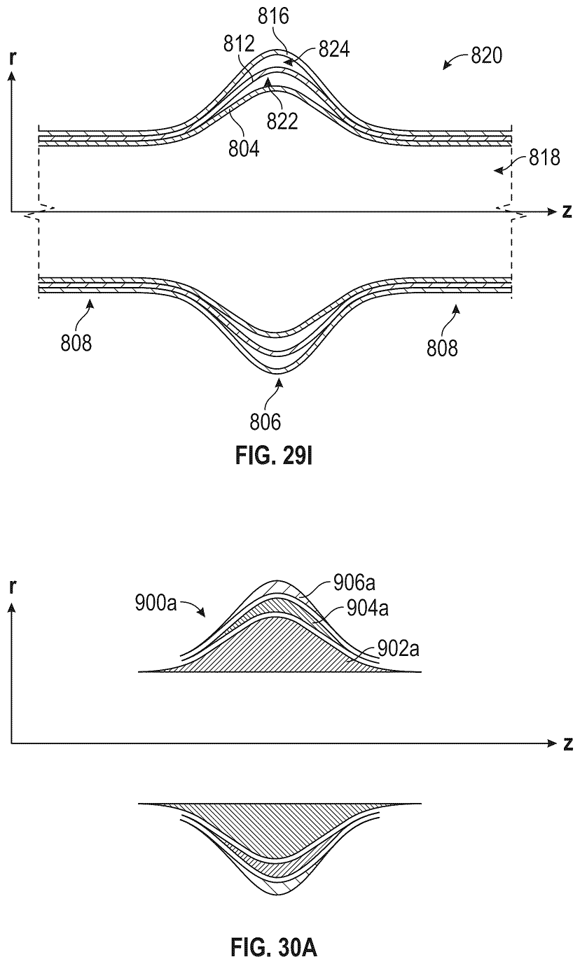

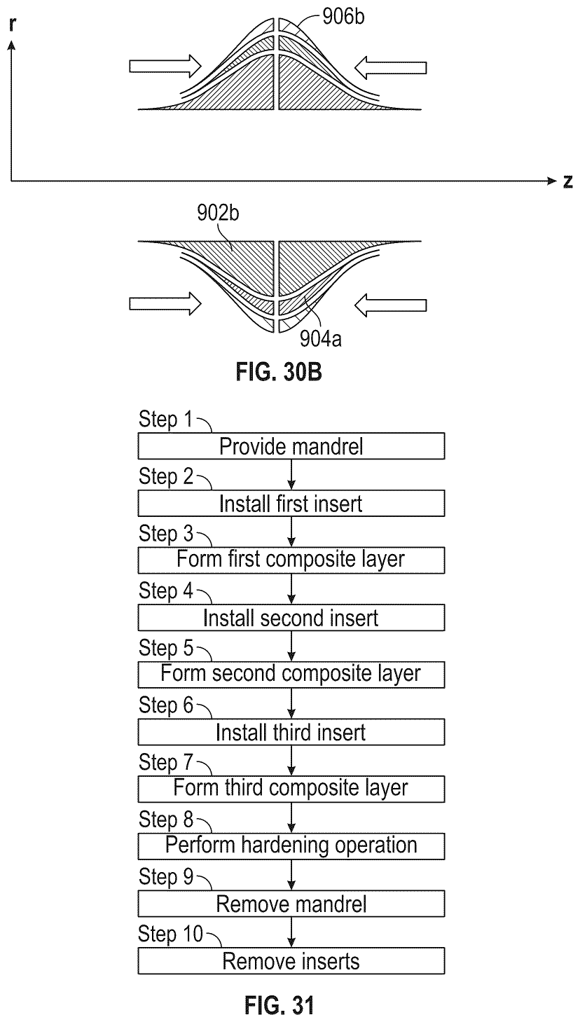

Referring now to FIGS. 30A-30B, schematic illustrations of insert assemblies 900a, 900b, respectively, are shown. The insert assemblies 900a, 900b may be used in the manufacturing process described above with respect to FIGS. 29A-29I. In FIG. 30A, the insert assembly 900a is formed of a set of inserts 902a, 904a, 906a, which are arranged to form a set of inserts for installation on a central mandrel or otherwise used in a process for making a composite drive shaft. The inserts 902a, 904a, 906a may be circumferentially segmented structures that are assembled about a central mandrel, such as shown and described with respect to FIG. 25. In FIG. 30B, the insert assembly 900b is formed of a set of inserts 902b, 904b, 906b, which are arranged to form a set of inserts for installation on a central mandrel or otherwise used in a process for making a composite drive shaft. The inserts 902b, 904b, 906b may be axially segmented structures that are assembled about a central mandrel. As shown in FIG. 30B, illustratively, the different segments of each insert 902b, 904b, 906b may be installed from opposite sides, such that the two segments are joined together at an axial location along the shaft structure to define an undulating portion. In some embodiments, the inserts may be both axially and circumferentially segmented. Further, it will be appreciated that other segmentations of the inserts may be employed without departing from the scope of the present disclosure.

Referring now to FIG. 31, an example manufacturing flow process is shown for making a composite drive shaft in accordance with an embodiment of the present disclosure. The flow process may substantially track the manufacturing process described with respect to FIGS. 29A-29I.

At Step 1, an optional step, a temporary metallic mandrel is installed or provided (e.g., FIG. 29A). In other embodiments, a washable mandrel may be provided.

At Step 2, a first washable insert is installed to the mandrel. In the case of a metallic mandrel, the first washable insert may be attached to or applied to the metallic mandrel. In the case of a washable mandrel, the first washable insert may be formed with the washable mandrel to form a single, unitary mandrel structure having bulges defining the first washable insert structure (e.g., FIG. 29B). The first washable insert (whether separate or integral with the mandrel) will define an undulation with narrow portions defined axially extending from the undulation. It will be appreciated that a series or set of first washable inserts may be applied to define multiple undulating portions (e.g., as shown in FIGS. 16A-22).

At Step 3 (e.g., FIG. 29C), a first composite layer is formed. The first composite layer is formed by wrapping, winding, applying, placing, or otherwise assembling onto the mandrel and first washable insert a first set of composite elements, such as shown and described above. At the location of the washable inserts, an undulating portion is defined and narrow portions are defined axially extending from the undulating portion(s). The first set of composite elements may be arranged at a first angle +α relative to an axis through the mandrel or assembly.

At Step 4 (e.g., FIG. 29D), a second washable insert is installed over the first composite layer. The second washable insert is installed axially aligned with and radially outward from the first washable insert. In some embodiments, the number of second washable inserts installed may be equal to the number of first washable inserts that are installed, such that each undulating portion is substantially similar.

At Step 5 (e.g., FIG. 29E), a second composite layer is formed by wrapping, winding, applying, placing, or otherwise assembling onto the first composite layer and the second washable insert a second set of composite elements. The second set of composite elements may be arranged at a different angle relative to the axis than the first set of composite elements. For example, the second set of composite elements may be oriented at an angle −α, which may be opposite the first angle +α, relative to the axis of the mandrel or assembly. In the location of the undulating portion (e.g., at the first and second inserts) the material of the second composite layer is prevented from contacting the material of the first composite layer due to the inclusion of the second washable insert. In some embodiments, the second composite layer may have a (radial) material thickness that is about twice a (radial) material thickness of the first composite layer. In embodiments that include only two composite layers (e.g., FIG. 26), the process may proceed to the curing and removal steps described below. In some such embodiments, the two composite layers may have substantially the same (radial) material thickness.

At Step 6, a third washable insert is installed to the assembly (e.g., FIG. 29F). The third washable insert is installed over the second composite layer at the location of the undulating portion. That is, the third washable insert is installed at an axial position aligned with the first and second washable inserts and radially outward therefrom. At Step 6, after the third washable insert is installed, the manufacturing assembly will include the mandrel as a central portion, and radially outward therefrom (at the undulating portion) is the first insert, the first composite layer, the second insert, the second composite layer, and the third insert installed thereon. Along the narrow portions of the assembly, stacked or layered radially outward from the mandrel is the first composite layer and the second composite layer, which may be arranged in contact with each other such that the material thereof may be bonded to form fixed or rigid connections therebetween.

At Step 7, a third composite layer is formed by wrapping, winding, applying, placing, or otherwise assembling onto the second composite layer and the third washable insert a third set of composite elements. The third set of composite elements may be arranged at a different angle relative to the axis than the second set of composite elements and may be, in some embodiments, the same angle as the first set of composite elements. For example, the third set of composite elements may be oriented at an angle +α, which may be opposite the second angle −α and equal to the first angle +α relative to the axis of the mandrel or assembly. In the location of the undulating portion (e.g., at the first, second, and third inserts) the material of the third composite layer is prevented from contacting the material of the second composite layer due to the inclusion of the third washable insert. In some embodiments, the third composite layer may have a (radial) material thickness that is equal to a (radial) material thickness of the first composite layer and half the (radial) material thickness of the second composite layer.

At Step 8, a hardening operation is performed on the assembly. In configurations that use thermoplastic for the composite elements of the composite layers, a solidifying step for hardening of a thermoplastic polymeric matrix may be completed. In configurations that use thermoset materials for the composite elements of the composite layers, a curing process may be performed to solidify and set a thermoset polymeric matrix. It will be appreciated that other hardening techniques and/or mechanisms may be employed to form the web structures of the formed composite shafts based on the material thereof, as will be appreciated by those of skill in the art.

At Step 9, if a metallic mandrel was employed, the metallic mandrel may be removed. It will be appreciated that although a metallic mandrel is described, in other configurations, the material of the mandrel is not limited to metal materials, but may be formed from any appropriate material as will be appreciated by those of skill in the art.

At Step 10, the inserts are removed. The material of the inserts is selected to be washable such that a washing operation is performed to remove the material of the inserts. The washing operation may also be used to remove the mandrel if the mandrel is formed from a washable material. In such cases, optional Step 9 may be eliminated, or Step 9 may be used to wash out the mandrel in advance of washing out the inserts. With the material of the mandrel and the inserts removed, a composite material shaft is formed. The composite shaft will include narrow portions and undulating portions. At the location of the narrow portions, the various layers that were applied to form the composite shaft will be bonded or otherwise joined together at junctions or intersections between composite elements of the respective composite layers. At the undulating portions, the stacked layers of composite elements are not connected, as the inserts provide for gaps to be defined between the layers (in the radial direction), resulting in separate layers that allow for more flexibility in the axial or bending directions while maintaining structural rigidity and stiffness with respect to transmission of torque along the length of the composite shaft.

Applications of fiber-reinforced polymer-matrix composite materials for drive shaft bodies can provide significant advantages with respect to the overall weight versus more traditional fully metallic shafts or composite shafts with metallic flexible diaphragms. Additional benefits associated with fully integrated composite drive shafts are opportunities for material design optimization, such as by placing high-strength fibers (e.g., carbon, glass, or organic (e.g., Kevlar) fibers), in orientations of maximal structural impacts. Therefore, fully integrated composite coupling and shaft body systems can be highly weight-efficient load bearing structures for aircraft applications. Furthermore, fabrication of shafts may be improved through embodiments of the present disclosure. For example, fabrication of an entire integrated structure as one piece can provide improvements and/or reductions in time and cost of fabrication. Further, for example, various fabrication steps required for other types of shafts may be eliminated, such as independent fabrication of relatively expensive flexible metallic diaphragms. In accordance with embodiments of the present disclosure, the flexibility of the composite shaft may be provided through the undulating portions of the composite shafts, with additional flexibility provided by the gaps between the composite elements along the undulating portions.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the apparatus and methods of the subject disclosure have been shown and described, those skilled in the art will readily appreciate that changes and/or modifications may be made thereto without departing from the scope of the subject disclosure.

What is claimed is:

1. A composite shaft comprising:
a plurality of composite elements arranged about an axis to form a hollow axisymmetric shaft, wherein the plurality of composite elements comprises:
a first group of the composite elements arranged about the axis offset by an angle +α; and
a second group of the composite elements arranged about the axis offset by an angle −α to form a web with the first group of the composite elements;
wherein the first and second groups of the plurality of composite elements are configured to cooperate to allow the hollow shaft to be flexible under bending and/or axial load and stiff under rotational load;
wherein the hollow shaft comprises one or more axisymmetric radially-outward undulating portions and one or more axisymmetric narrow portions, wherein the narrow portions define a minimum inner diameter of the hollow shaft and the undulating portions define bulges having a larger inner diameter than the minimum inner diameter; and
wherein the composite elements of the first group are connected to the composite elements of the second group in the radial direction along the narrow portions and the composite elements of the first group are not connected to the composite elements of the second group in the radial direction along the undulating portions.

2. The composite shaft of claim 1, wherein the second group is applied radially outward from the first group.

3. The composite shaft of claim 1, further comprising a third group of the composite elements arranged about the axis offset by the angle +α to form a web with the first and second groups of the composite elements.

4. The composite shaft of claim 3, wherein the second group of composite elements has a material thickness in the radial direction that is approximately equal to a material thickness of the first group plus the third group in the radial direction.

5. The composite shaft of claim 1, wherein a radial gap is defined between the composite elements of the first group and the composite elements of the second group along an axial length of the undulating portion.

6. The composite shaft of claim 1, wherein the hollow shaft comprises a plurality of axisymmetric radially-outward undulating portions and a plurality of narrow portions that are arranged in an alternating pattern with each undulating portion arranged between two narrow portions on either side of the undulating portion in an axial direction.

7. The composite shaft of claim 1, further comprising one or more reinforcement elements arranged at the narrow portions.

8. The composite shaft of claim 7, wherein the one or more reinforcement elements comprise composite elements arranged at least one of axially, circumferentially, or at a non-zero angle about the hollow shaft.

9. The composite shaft of claim 1, wherein each of the angle +α and the angle −α is between 30 and 60 degrees.

10. A method of making a composite shaft, the method comprising:
providing a mandrel having a substantially cylindrical shape and defining an axis;
installing one or more first inserts along an axial length of the mandrel;
arranging a first group of axisymmetric composite elements about the axis offset by an angle +α, wherein the first group of composite elements is applied to the mandrel along axial lengths defining narrow portions of a formed composite shaft and the first group of composite elements is applied to the one or more first inserts along axial lengths defining one or more undulating portions of the formed composite shaft;
installing one or more second inserts along the axial length of mandrel, wherein at least one of the one or more first inserts has a respective second insert installed radially outward therefrom and axially aligned therewith; and
arranging a second group of composite elements arranged about the axis offset by an angle −α to form a web with the first group of composite elements, wherein the second group of composite elements is applied to the first group of composite elements along the axial lengths defining the narrow portions of the formed composite shaft and the second group of composite elements is applied to the one or more second inserts along the axial lengths defining the one or more undulating portions of the formed composite shaft.

11. The method of claim 10, wherein the composite elements are made of thermoset materials, the method further comprising performing a curing operation to harden the thermoset material.

12. The method of claim 10, further comprising:
installing one or more third inserts along the axial length of mandrel, wherein the one or more first insert having a respective second insert has a respective third insert installed radially outward from the second insert and axially aligned therewith; and
arranging a third group of composite elements arranged about the axis to form a web with the first and second groups of composite elements, wherein the third group of composite elements is applied to the second group of composite elements along the axial lengths defining the narrow portions of the formed composite shaft and the third group of composite elements is applied to the one or more third inserts along the axial lengths defining the one or more undulating portions of the formed composite shaft.

13. The method of claim 12, wherein the second group of composite elements has a material thickness in the radial direction that is about equal to a material thickness in the radial direction of the first group plus a similar thickness of the third group in the radial direction.

14. The method of claim 12, wherein the composite elements are made of thermoset materials, the method further comprising performing a curing operation to harden the thermoset material.

15. The method of claim 12, further comprising:
removing the mandrel, the one or more first inserts, the one or more second inserts, and the one or more third inserts, to leave gaps between the first group of composite elements and the second group of composite elements along the axial length of the undulating portions and to leave gaps between the second group of composite elements and the third group of composite elements along the axial length of the undulating portions.

16. The method of claim 10, further comprising:
removing the mandrel, the one or more first inserts, and the one or more second inserts to leave gaps between the first group of composite elements and the second group of composite elements along the axial length of the one or more undulating portions.

17. The method of claim 10, wherein each of the one or more first inserts each comprises a segmented ring.

18. The method of claim 10, wherein each of the one or more second inserts each comprises a segmented ring.

19. The method of claim 10, further comprising installing reinforcement elements at the narrow portions.

20. The method of claim 19, wherein the reinforcement elements comprise composite elements arranged at least one of axially, circumferentially, or at a non-zero angle about the hollow shaft.
